(19) United States
(12) Patent Application Publication
(10) Pub. No.: US 2015/0225973 A1
(43) Pub. Date: Aug. 13, 2015

(54) OVERSEAS VEHICLE SEGMENTED ENCLOSURE SYSTEM

(71) Applicant: Mobile Medical International Corporation, Saint Johnsbury, VT (US)

(72) Inventors: Dana G. Patoine, Sutton, VT (US); Richard Pike, Saint Johnsbury, VT (US); Philip T. Cantin, Guidehall, VT (US)

(21) Appl. No.: 14/424,798

(22) PCT Filed: Sep. 3, 2013
(86) PCT No.: PCT/US13/57829

§ 371 Date: Feb. 27, 2015

Related U.S. Application Data
(60) Provisional application No. 61/695,800, filed on Aug. 31, 2012.

(51) Int. Cl. E04H 1/12; E04B 1/348; B64D 9/00

(52) U.S. Cl. CPC E04H 1/12; B64D 9/00; E04B 1/348; E04H 2001/1283

(57) ABSTRACT

A module of a transportable segmented enclosure system, including a first walled structure encompassing a volume having a longitudinal axis, the walled structure having at least a first opening, the longitudinal axis passing through the first opening, and a seal apparatus located proximate the first opening, wherein the seal apparatus is configured to form a seal between the first walled structure and another module having a walled structure when the seal of the first walled structure is positioned against the another module.

### CROSS-REFERENCE TO RELATED APPLICATIONS

This application claims the benefit of U.S. Provisional Patent Application No. 61/695,800, filed Aug. 31, 2012. The content of this application is hereby incorporated by reference herein.

### BACKGROUND

Portable shelters are often used to provide temporary facilities for various purposes, such as military, civilian, and medical applications. Such portable shelters may be used to supplement permanent structures when additional space is desired, or to provide new facilities for temporary use, such as the provision of emergency response services after a disaster. Motorized land vehicles, such as vans, buses, and recreational vehicles (RVs), etc., are sometimes used as portable shelters under certain circumstances.

### SUMMARY

Embodiments of the disclosed technology include a module of a transportable segmented environment enclosure system, comprising a first walled structure encompassing a volume having a longitudinal axis, the walled structure having at least a first opening, the longitudinal axis passing through the first opening and a seal apparatus located proximate the first opening, wherein the seal apparatus is configured to form a seal between the first walled structure and another module having a walled structure when the seal apparatus of the first walled structure is positioned against the another module.

Embodiments of the disclosed technology also include a transportable segmented enclosure system. The transportable segmented enclosure system comprises a module; and at least a second module including: a second walled structure encompassing a second volume having a second longitudinal axis, the second walled structure having at least a second opening, the longitudinal axis passing through the second opening, wherein first module and the second module are configured to be secured to one another and/or to another assembly such that the first opening is proximate the second opening and the seal apparatus forms a seal between the first module and the second module abut the first and second openings.

Embodiments of the disclosed technology also include an overseascraft. The overseascraft comprises: an aircraft including a cabin; and a transportable segmented enclosure system, including: a module; and at least a second module including: a second walled structure encompassing a second volume having a second longitudinal axis, the second walled structure having at least a second opening, the longitudinal axis passing through the second opening, wherein first module and the second module are located in the cabin and secured to one another and/or to the aircraft such that the first opening is proximate the second opening and the seal apparatus forms a seal between the first module and the second module abut the first and second openings.

Embodiments of the disclosed technology also include a craft. The craft comprises: an enclosure system having an enclosure including at least a first floor segment, wherein an outer profile of the enclosure system lying on a plane normal to the first floor segment and passing therethrough and normal to a longitudinal axis of the system includes an outer profile having a compound shape; and a boat or an aircraft having an interior including an interior boundary enveloping the outer profile, wherein at least one utility conduit is located in a recess of the compound shape between the interior boundary and the outer profile.

Embodiments of the disclosed technology also include a method of processing medical supplies in an overseascraft. The method comprises: passing a soiled medical supply from an operating room into a first compartment within a module in the craft; cleaning the soiled medical supply while the supply is in the first compartment; passing the cleaned medical supply from the first compartment into a second compartment adjacent the first compartment, the first compartment being within the module; sterilizing the cleaned medical supply while the supply is in the second compartment; and passing the sterilized medical supply back into the operating room.

Embodiments of the disclosed technology also include a module of an aircraft transportable facility. The module comprises: a first walled structure encompassing a first volume and having a first longitudinal axis, wherein the walled structure is of sufficient rigidity to support from a ceiling wall a mass of about 100 kg without substantial deformation of the walled structure in a 1.5 G environment.

Embodiments of the disclosed technology also include n aircraft transportable segmented facility. The aircraft transportable segmented facility comprises: a module including a first opening, the longitudinal axis passing through the first opening; and at least a second module including: a second walled structure encompassing a second volume having a second longitudinal axis, the second walled structure having at least a second opening, the longitudinal axis passing through the second opening, wherein the first module and the second module are configured to be secured to one another and/or to another assembly such that the first opening is proximate the second opening.

### BRIEF DESCRIPTION OF THE DRAWINGS

Embodiments of the disclosed technology are described below with reference to the attached drawings, in which:

FIG. 1 depicts an isometric view of an aircraft and an enclosure system according to an exemplary embodiment;

FIG. 2A depicts a cross-sectional view of the aircraft and enclosure system of FIG. 1;

FIG. 2B depicts an isometric view of the enclosure system of FIG. 1;

FIG. 3 depicts an isometric view of a module of the enclosure system of FIG. 1;

FIG. 4 depicts an isometric view of an alternate embodiment of a module of the enclosure system of FIG. 1;

FIG. 5A depicts additional details of the module of FIG. 2B;

FIG. 5B depicts an cross-sectional view of the seal of the module of FIG. 5A, along with a cross-sectional view of an exemplary piece of structure supporting the seal;

FIG. 5C depicts a cross-sectional view of the seal of FIG. 5B in use;

FIG. 5D depicts an alternate embodiment of a sealing system usable with the enclosure system of FIG. 1;

FIG. 6 depicts an alternate embodiment of the module of FIG. 2B;

FIG. 7 depicts a plurality of modules according to the module of FIG. 6 connected to one another via an exemplary coupling system;

FIGS. 8 and 9 depict an exemplary coupling system according to an embodiment;

FIG. 10 depicts an alternate embodiment of the module of FIG. 2B;

FIGS. 11A and 11B depict a conceptual representation of the effects of shear on module walls;

FIG. 12 depicts FIG. 10 depicts an alternate embodiment of the module of FIG. 2B;

FIG. 13 depicts a cross-sectional view of the system and craft of FIG. 1 depicting an exemplary placement of utility conduit relative to the system and the aircraft interior;

FIG. 14 depicts a cross-sectional view of the system and craft of FIG. 1 depicting a module of the system having access to an underfloor area of the craft;

FIG. 15 depicts an alternate embodiment of the module of FIG. 2B;

FIGS. 16 and 17 depict a floor plan of a medical supply management facility according to an embodiment;

FIG. 18 is a perspective view of the medical supply management facility looking from the top left side of the aircraft in a slightly forward direction;

FIG. 19 is a perspective view of the medical supply management facility looking from the top slightly on the right of the aircraft slightly forward;

FIG. 20 is a perspective view of the medical supply management facility looking from the top slightly on the left side of the aircraft slightly backward;

FIG. 21 is a perspective view of the medical supply management facility looking from the top right side of the aircraft slightly backward; and

FIG. 22 is a perspective view of the medical supply management facility looking from the top slightly on the left side of the aircraft looking slightly forward.

FIG. 23 illustrates another embodiment of a module;

FIG. 24 illustrates a wall section of the present technology in a projection view;

FIG. 25 illustrates a wall section of the present technology in front and side views;

FIG. 26 illustrates the wall section of the present technology in side and section views illustrating a first flange and a second flange;

FIG. 27 illustrates an alternative embodiment of the second flange of the present technology;

FIG. 28 is an expanded partial cross-section view illustrating a wall panel at the joint between wall sections of FIG. 1, FIG. 2, and FIG. 3 in accordance with the present technology;

FIG. 29 is an expanded top view of the joint of a wall panel between wall sections in accordance with the present technology; and

FIG. 30 is a flow chart describing assembly of a wall panel from wall sections.

FIG. 31 is a perspective view of a wall panel in accordance with the present technology.

FIG. 32 illustrates wall panels of the present technology assembled in a frame to form a wall in accordance with the present technology.

FIG. 33A illustrates wall panels in an eight-sided frame as part of forming a wall with a portal of the present technology.

FIG. 33B illustrates wall panels in an eight-sided frame having flats securing the wall panels within the frame to form a wall with a portal of the present technology.

FIG. 34 illustrates a module built using sections and panels of the present technology.

FIG. 35 illustrates walls of an exemplary module, and wall sections thereof; and

FIG. 36 depicts a cross-sectional view of a portion of the module of FIG. 34.

### DETAILED DESCRIPTION

As noted above, embodiments of the technology disclosed herein have utility with respect to mobile enclosures. In particular, embodiments of the technology disclosed herein are directed to mobile enclosures of a kind that form an enclosure inside another vehicle (hereinafter often referred to as a transportable enclosure system). In some exemplary embodiments of some such enclosures, embodiments of the technology disclosed herein are directed to mobile enclosures of a kind that form an environmental barrier between an environment outside of the enclosure and that inside the enclosure (hereinafter often referred to as a transportable environmental barrier system). While the enclosure can serve many purposes, many embodiments are directed towards establishing a barrier at the microscopic level and/or the magnifyic level (establishing an enclosure directed at limiting movement, or at least the uncontrolled movement, of compounds (e.g., carbon dioxide), mixtures (e.g., air), bacteria and/or viruses outside the enclosure, with respect to the microscopic level and/or dust, aerosols, vapor, etc., at the mangifyic level). Some embodiments are also directed towards establishing a barrier at a general level (e.g., people control, equipment control, sound control, etc.), where such a barrier may have utility in serving as a way to avoid inadvertent interaction between certain people (e.g., a surgery patient undergoing surgery and non-medical personnel, etc.). Embodiments detailed herein and/or variations thereof can be applicable to transportable enclosures and/transportable environmental barrier systems used with aircraft and/or seacraft (hereinafter often referred to as overseascraft, as distinguished from landcraft such as tractor trailers). In some embodiments, these enclosures are located entirely within the confines of the overseascraft, and the enclosure forms an enclosure between the general environment within the overseas craft (e.g., cabin of an aircraft, cargo hold of a ship) and the environment within the mobile shelter (within the enclosure). In an exemplary embodiment, the enclosure comprises one or more modules, where the modules are secured in and/or transported in the overseascraft in a manner the same as and/or similar to cargo containers to which the aircraft is configured to transport. Such a feature has utility in that an aircraft enclosure can be established (e.g., by securing the module(s) therein) within a United States Federal Aviation Administration (FAA) certified cargo aircraft without the necessity of recertifying the aircraft. This as opposed to modifying the interior of the certified aircraft (e.g., placing new walls, support fixtures, etc., in the aircraft) to create the enclosure, even if only temporarily, therein.

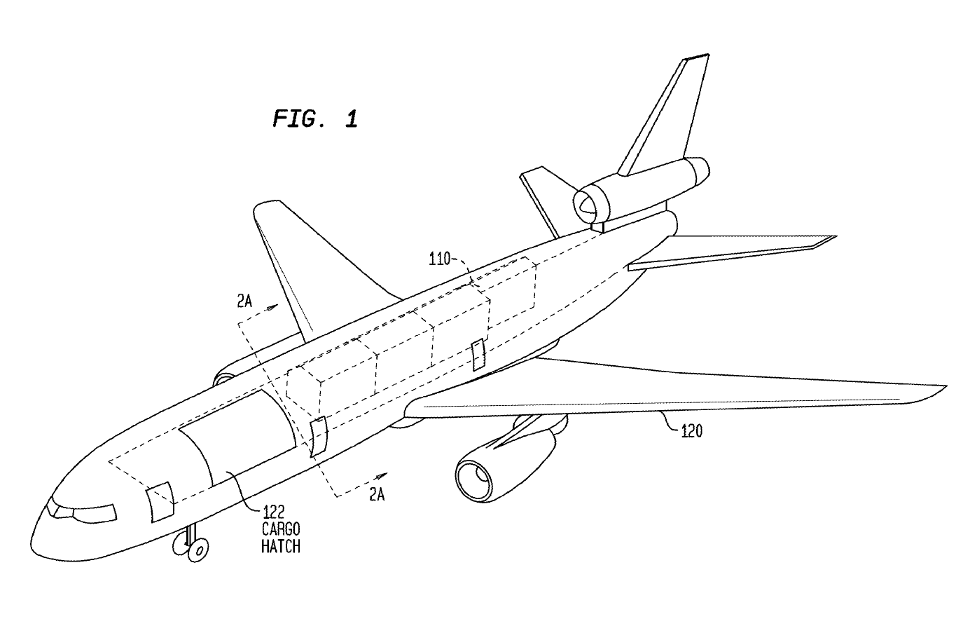

The modules can be rigid walled structures, as detailed below. FIG. 1 depicts an exemplary embodiment of an exemplary enclosure system 110 in use with an aircraft 120, where a portion of the aircraft has been cut away for clarity.

In an exemplary embodiment, the enclosure system 110 is utilized to perform general surgery and/or specific surgery (e.g., eye surgery, plastic surgery, etc.) and/or diagnostic procedures (e.g., blood analysis, scans such as X-ray scans, etc.) therein while inside the aircraft, as will be described in greater detail below. First, some exemplary embodiments of the enclosure system 110 will now be described, along with use thereof with the given overseas craft.

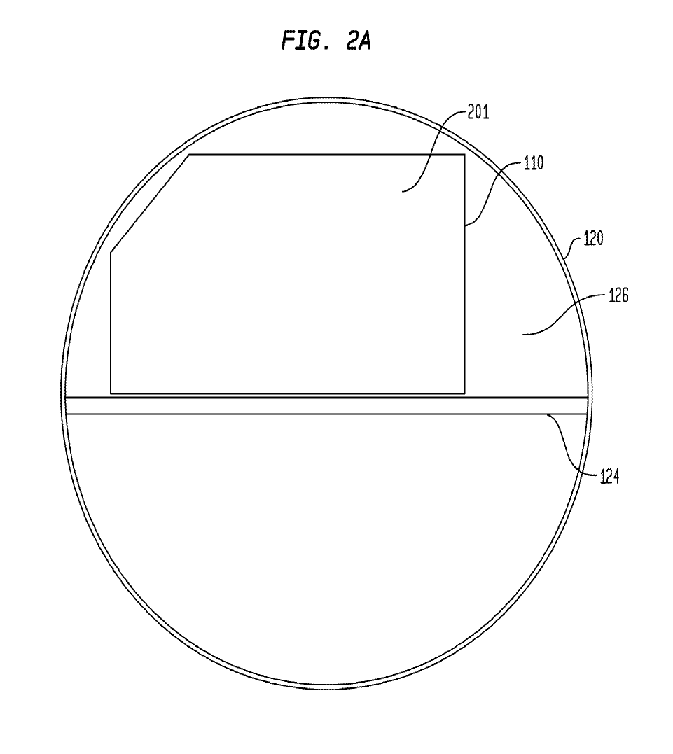

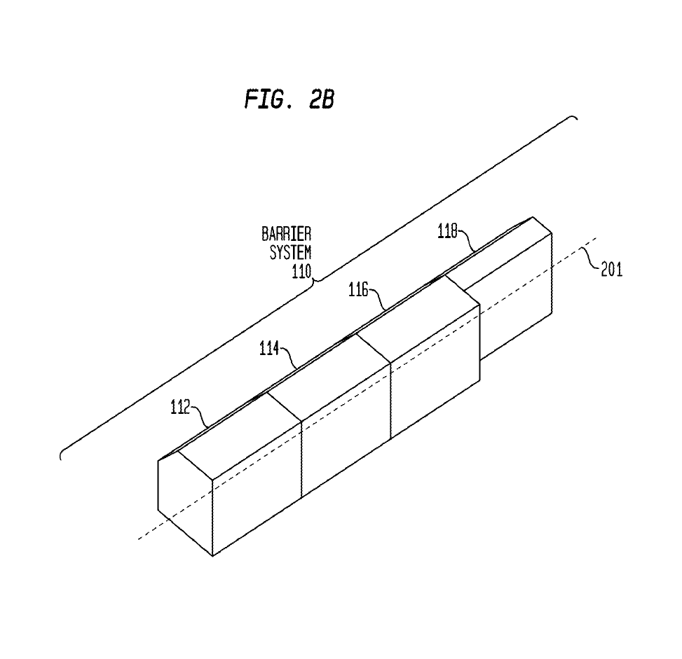

FIG. 2A depicts a cross-sectional view of FIG. 1, showing that at least a portion of an outer boundary lying on a plane normal to the longitudinal axis 201 of the system has a compound shape, owing to the presence of the chamfered section of the boundary. FIG. 2B depicts the enclosure system 110 of FIG. 1 without the aircraft 120. As may be seen, enclosure system 110 is made up of a plurality of modules, including modules 112, 114, 116 and 118, with module 118 being diminutive with respect to at least its lateral dimensions than the other modules as it is located closer to the tail of the aircraft 120, where the fuselage tapers inward. FIG. 2B depicts the modules coupled together extending along longitudinal axis 201.

It is noted that exemplary transportable environmental barrier systems may include more or fewer modules than that depicted in FIG. 2B. In this regard, the systems detailed herein are presented for conceptual purposes. Also, in some embodiments, a system may utilize modules having any size or shape or structural configuration, or any number of modules, that will enable the teachings detailed herein and/or variations thereof to be practiced.

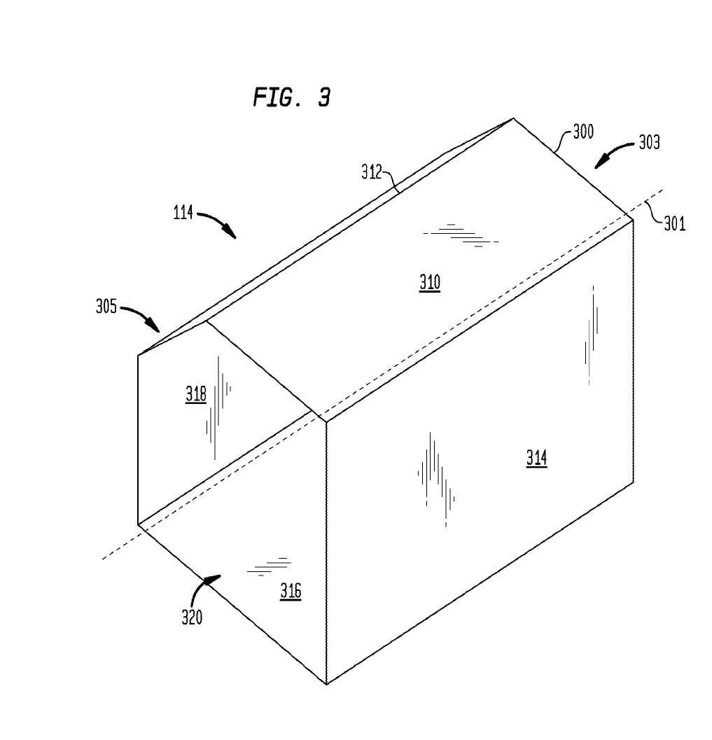

FIG. 3 depicts a view of one of the modules, module 114, in isolation from the other modules. Module 114 comprises a walled structure 300 made up of walls 310, 312 (corresponding to the chamfer seen in FIG. 2A), 314 and 316 (where wall 316 is utilized as a floor due to its orientation with respect to the direction of gravity—herein, a traditional wall will be referred to as a “sidewall”) encompassing a volume 320. It is noted that in an exemplary embodiment, wall 316 is a pallet similar to and/or the same as a pallet utilized for cargo transport on a DC-10 cargo aircraft or the like, to which the sidewalls are attached in a rigid manner. Some specific construction features of the structure of walled structure 300 are described below.

Module 114 includes a longitudinal axis 301 extending through the volume located at a geometric center of the volume. In the embodiment of FIG. 3, module 114 does not include walls at end 303 or 305 as module 114 is a middle module used to expand, in a generally unobstructed fashion, the volume resulting from connection of module 112 and module 116 to module 114. Accordingly, module 114 includes openings at ends 305 and 303. This as contrasted to, for example, module 112, which can be considered identical to module 114 with respect to its walls except for the fact that it includes a wall on the opposite side from which it connects to module 112 (the side where it contacts module 114 is without a wall in an exemplary embodiment, thus resulting in the generally unobstructed volume just detailed. As will be detailed below, in other embodiments, module 114 may have a wall at one or both ends.

System 110 is segmented so that it may be placed inside the confines of the cabin of aircraft 120 without significantly structurally altering the aircraft (beyond placing a cargo hatch or the like in the fuselage if one is not present—cargo versions of the McDonnell Douglas DC-10 and Boeing 777 have such cargo hatches). In this regard, in an exemplary embodiment, the modules are of a size and shape such that they can be moved horizontally through cargo hatch 122 (see FIG. 1) in the forward section of the aircraft and/or a cargo hatch located elsewhere, into the cabin (i.e., area of the aircraft 120 above floor section 124 (see FIG. 2A) to rest on floor section 124 as depicted in FIG. 2A. After this, the modules are moved rearward (or forward, in the case of a rear hatch), to make room for another module. In this regard, with respect to FIG. 2A, a loading procedure may entail first placing module 118 into the cabin through the hatch, and then moving it rearward, followed by placing module 116 into the cabin through the hatch, and then moving it rearward to be adjacent module 118, followed by placing module 114 into the cabin, and then moving module 114 rearward to be adjacent module 116, etc. Upon attachment of the modules together as detailed below, the connected modules collectively form the system 110 enclosed within the cabin of aircraft 120.

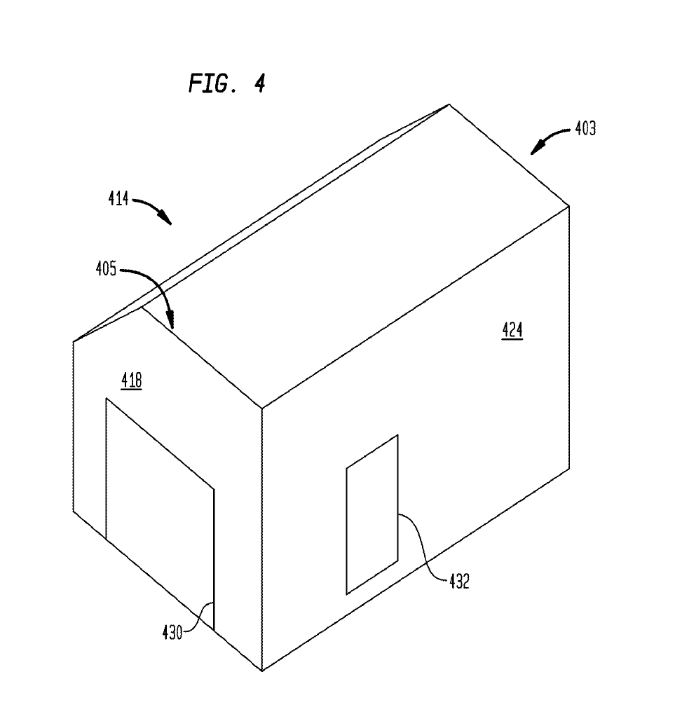

FIG. 4 depicts an alternate embodiment of a module, module 414, which can be utilized in system 110 instead of module 114. The wall structure of module 414 is generally identical to that of module 114 with the exception that it includes wall 430, as may be seen, at end 405, and/or a wall section at end 403 (not seen). Wall section 418 includes a door 430 that permits access between the volume enclosed by module 414 and that enclosed by module 112 while also permitting movement between the two volumes to be restricted and/or prevented. Door 430 may be, in some embodiments, an accordion door or an overhead door to close a larger opening, such an opening that can accommodate an gurney or the like. In this regard, the opening closed by the door 430 is generally flush with the floor of the module 414 (and thus module 112 to which it is connected) so as to permit the wheels of the gurney to traverse the boundary between the two modules with minimal vertical movement. The configuration of end 405 may be found on end 403 as well in addition to this or in the alternative.

Wall section 314 and/or wall section 424 may also have a door 432 or other type of passageway therethrough, in addition to or as an alternate to, door 430, as may be seen by way of example in FIG. 4 (which, in some embodiments, is an overhead door as depicted to close a lager opening). In this regard, in some embodiments, movement from the volume enclosed by module 114 or 414 is accomplished by exiting through a door in a wall corresponding to wall section 314, entering the cabin of the aircraft 120 in general and the port side of cabin 126 (see FIG. 2A) in particular, walking forward along the port side of cabin 122 to a door in wall section 314 of module 112, and passing through the door into the volume enclosed by module 112.

As noted above, in an exemplary embodiment of the enclosure system 110, the enclosure system establishes an enclosure between the ambient environment of the aircraft (or seacraft if used therewith) and the environment within the system 110. Accordingly, end(s) of at least some of the modules may include a seal to seal the modules together. While other structural fasteners or the like may be utilized to mechanically retain the modules together, the seals function, at least in some embodiments, primarily and/or exclusively as seals (as opposed to mechanical couplings), although in other embodiments, a seal-coupling arrangement may be utilized.

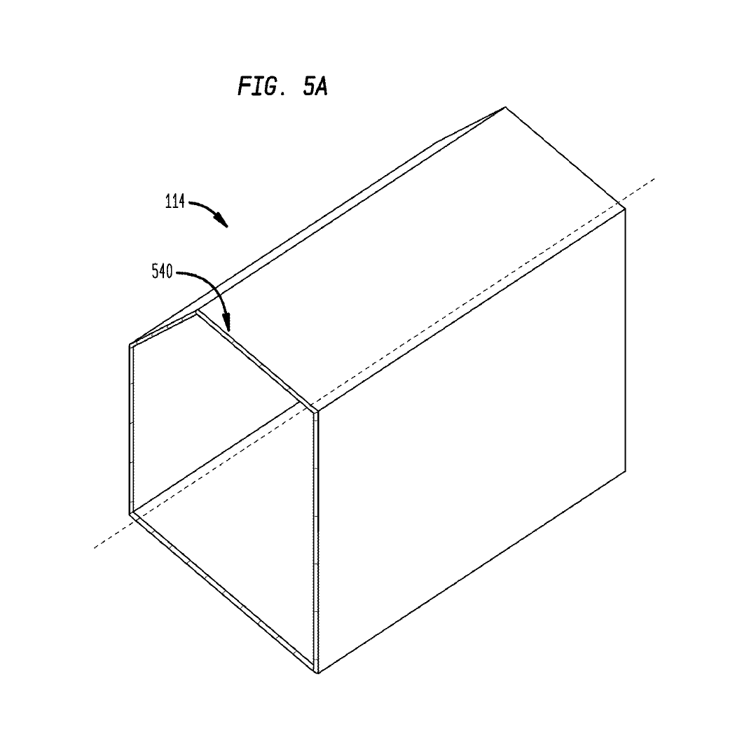

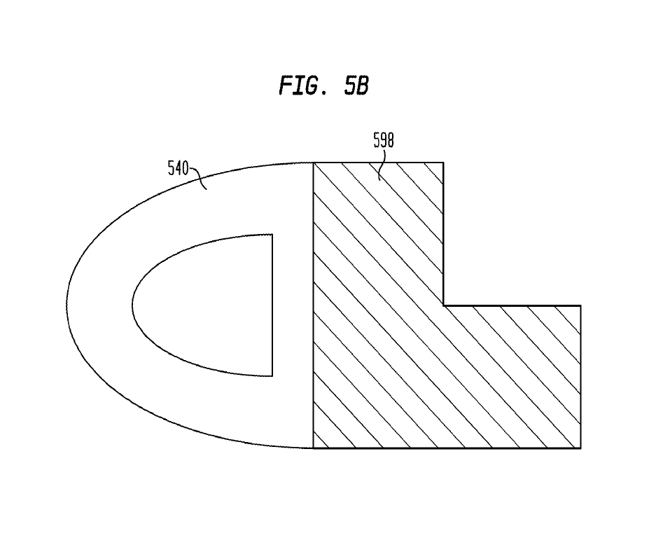

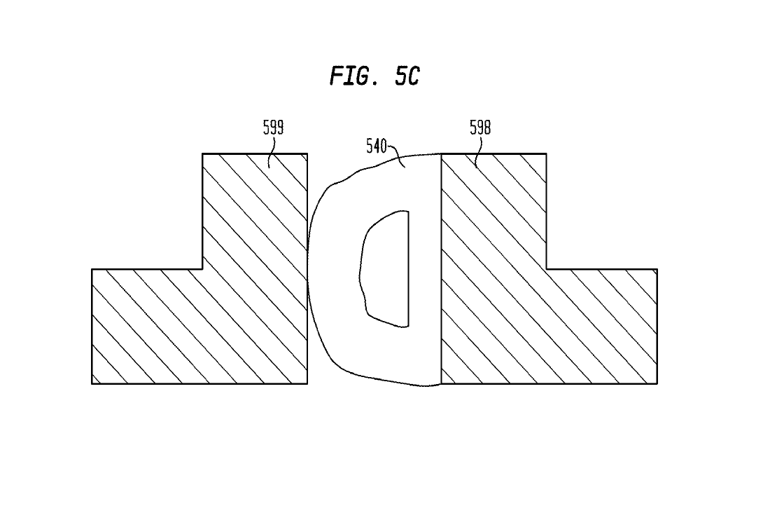

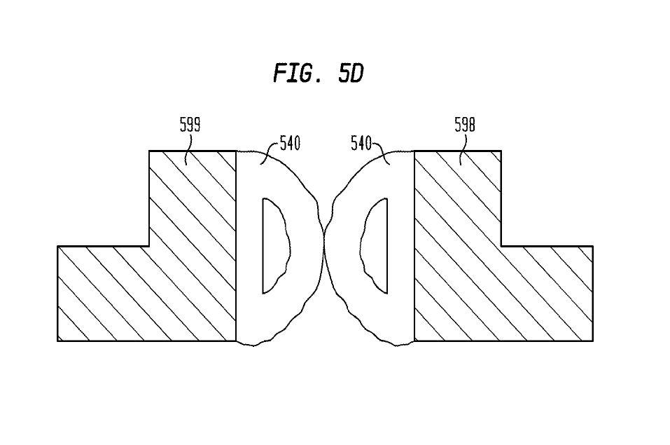

FIG. 5A depicts additional details of module 114, particularly, seal 540. Seal 540 extends completely about end 305 of module 114, either continuously, or in segmented components that provide a complete seal or a partial seal (in some embodiments, a gap may have utility). In an exemplary embodiment, seal 540 is a preformed elastomeric material having a preformed global shape corresponding to the shape of the end 305 of the wall structure 300. The seal can be a flexible seal that compensates, at least in part, for varying distance between modules due to, for example, strain of the aircraft 120 structure resulting from flight dynamics and/or temperature variation, etc., which is correspondingly transferred to the modules because, for example, the modules are fixed to the aircraft 120 in general (e.g., via the cargo loading/securing systems already in place on a cargo aircraft) and the floor section 124, and thus move with the portions of the aircraft (e.g., expand with expansion, compress with contraction, etc.).

In an exemplary embodiment, the seal 540 is configured to maintain sufficient flexure properties over a range of temperature extremes and gradients. For example, an operational scenario exists where the interior of the system 110 is air conditioned to a relatively low temperature, while the air in the cabin of the aircraft 120 is not so condition, and the aircraft, which might have aluminum skin, is located in a desert for an extended period of time at the height of the local summer, where the cargo door and other doors to the cabin of the aircraft are kept shut. In an exemplary embodiment, the seal 540 is a polymer that satisfies some or all of the aforementioned attributes of the seal. In an exemplary embodiment, the seal 540 is made out of rubber, silicone or other flexible low durometer or inflatable seal.

FIG. 5B provides an exemplary cross-sectional view of the seal 540, which in this embodiment, is a bulbous seal adhered to an L-shaped beam 598 of module 114, and FIG. 5C depicts exemplary flexure of the seal 540 in a state where it forms a seal between module 114 and 112, where L-shaped beam 599 is a corresponding beam of module 112, and where only module 114 has the seal (at least at this location). It is noted that other types of beams (e.g., C-shaped beams, box-beams, solid beams, etc.) may be used in lieu of the L-shaped beams). FIG. 5D depicts an exemplary embodiment where both modules 114 and 112 have such seals and the seals are forming a seal between the two modules.

In an alternate exemplary embodiment, the seal is a form-in-place gasket. Any sealing mechanism that will enable the teachings detailed herein and/or variations thereof may be practiced in at least some embodiments.

It is noted that a seal may also or alternatively be located on the opposite end (end 303) of module 114, and can serve to seal together module 114 and module 116. Alternatively or in addition to this, a separate seal may be located on the end of module 116 that is proximate end 303 of module 114. In this regard, in some embodiments, instead of or in addition to seal 540 being located on module 114, a seal is located on the end of module 112 that is proximate end 305 of module 114.

The sealing mechanisms can be such that the modules self-seal upon placement of a modules within sufficient proximity to one another and/or upon the application of sufficient compressive force between two or more modules. Alternatively or in addition to this, the sealing mechanisms may be include a seal that seals upon exposure to an alternate stimulus (e.g., UV light, water, etc.).

In an exemplary embodiment, the sealing mechanisms are configured to achieve a sealing quality that allows the module/s to be pressurized up to 0.1 WCI (water column inches). Along these lines, it is noted that the sealing mechanism need not form a hermetic seal. In this regard, a seal that is sufficient to prevent the ingress into the volume enclosed by the system of air or air particles past the seal in a scenario where the volume is overpressurized relative to the pressure of the cabin of the aircraft 120 (via, for example, sucking air from the cabin, filtering the air and directing the filtered air into the volume, thereby overpressuring the air therein can fall within the scope of a sealing mechanism). Alternatively and/or in addition to this, the seal can configured to limit and/or substantially prevent, flow of air from inside the system to outside the system, thus conserving, for example, energy by preventing excessive amounts of conditioned air from escaping the system 110.

Accordingly, an exemplary embodiment includes a module, such as module 114, of a transportable segmented environment enclosure system, such as system 110. The system can include a first walled structure, such as structure 300, encompassing a volume 321 having a longitudinal axis 301, the walled structure having at least a first opening (e.g., the opening at end 305), the longitudinal axis 301 passing through the first opening. The module 114 may further include a seal apparatus, such as seal 540, located proximate the first opening. The seal apparatus is configured to form a seal between the first walled structure 300 and another module (e.g., module 112) having a walled structure when the seal apparatus of the first walled structure 300 is positioned against the another module (e.g., module 112). In an exemplary embodiment, the seal apparatus is an elastomeric seal configured to at least elastically deform when the module 114 is positioned against the another module (e.g., module 112) such that a compressive force is applied to the seal apparatus as a result of the positioning. Such compression can result from, for example, the coupling of the modules together and/or the positioning of the modules within the aircraft and subsequent securement thereto. In this regard, modules may include mechanical couplings that couple the modules to one another. Depending on the design of the coupling, the coupling may result in the aforementioned compression. Alternatively or in addition to this, the modules may be sized and dimensioned such that when the modules are attached to a given cargo handling system of the aircraft, the modules are positioned relative to one another such that their positioning results in the aforementioned compression. A combination of the two may result in the aforementioned compression.

In an alternative embodiment, the seal apparatus is a seal that lays on the interior walls of the modules. In an exemplary embodiment, such a seal is akin to duct tape or the like when used to seal two abutting HVAC ducts together, although the seal need not include adhesive properties (mechanical fasteners may be utilized). Any device, system and/or method of sealing adjacent modules may be utilized in some embodiments.

An exemplary embodiment includes a plurality of modules that are sealed together in accordance with the teachings herein and/or variations thereof. In an exemplary embodiment, there is a transportable segmented enclosure system, such as by way of example a segmented barrier system, having modules so sealed such that the system is configured to maintain a pressure inside a volume thereof formed by at least some of collective volumes of the modules at a higher pressure than that outside the enclosure system inside the cabin.

As noted above, in an exemplary embodiment, the system 110 is configured to maintain the sealing characteristics in the presence of movement of one module relative to another as would be expected during normal usage of the overseascraft in which is located. Indeed, in an exemplary embodiment, the modules are configured to move relative to one another, at least in the longitudinal direction, as will be detailed below.

Some embodiments of the modules are such that each is configured to be structurally robust enough, by itself, to withstand the forces applied thereto during normal operation of the overseascraft. However, in some embodiments, some modules may be structurally inferior to others. Such may be the case where the needs of the interior volume are such that structural components are more sparingly used than in other modules. For example, while not shown in the FIGs., some modules may include interior walls delta to the walls depicted in the figures. These interior walls further strengthen the modules, and the absence of these walls render a module that may be structurally inferior to an adjacent module. Alternatively or in addition to this, in some embodiments, the walls of some modules are utilized to support heavy objects, especially from the ceiling walls (either inside the module or outside the module) and thus some modules will be more stressed than others under a given g-force environment. Accordingly, an exemplary embodiment includes a configuration of the system 110 in which a module adjacent a module that experiences a significant loading participates in supporting the module against the load, thus reducing the strain of the single module with respect to that which would be the case if the adjacent module was not so sharing in the distribution of the load.

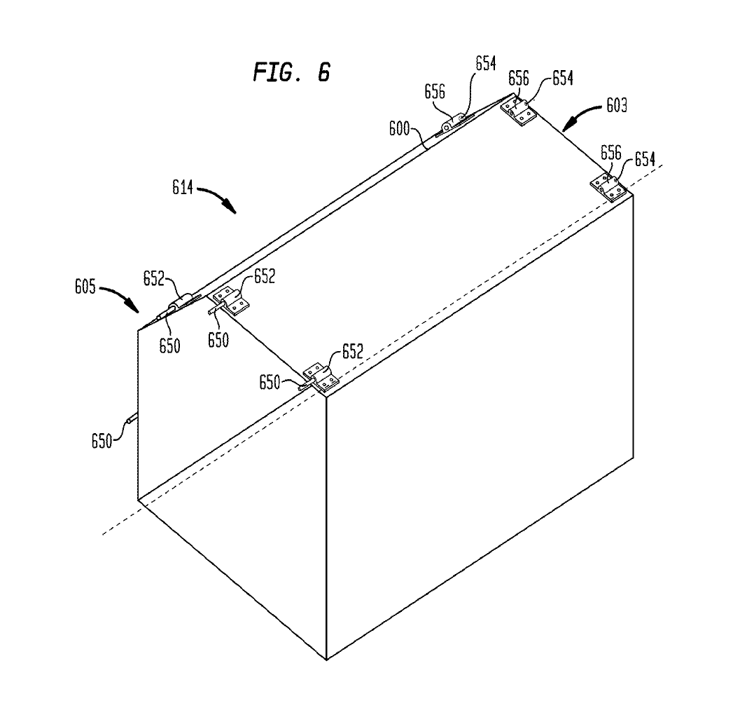

In an exemplary embodiment, the modules include a coupling arrangement that enables this load sharing. FIG. 6 conceptually depicts a module 614 having such an arrangement. In particular, module 614 includes pins 650 arrayed about the top and sides of the walled structure of the module 614. Pins 650 are mechanically fastened to the walls via respective brackets 652. In operation, pins 650 fit into bores of the module that is attached to the module 614, the bores being located at the end of the attaching module proximate the end 605 (the end where the pins 650 are located). In this regard, FIG. 6 depicts bores 654 located in fixtures 656 attached to the walled structure 600 at end 603 of the module 614, which receive corresponding pins of the module that attaches at the end 603.

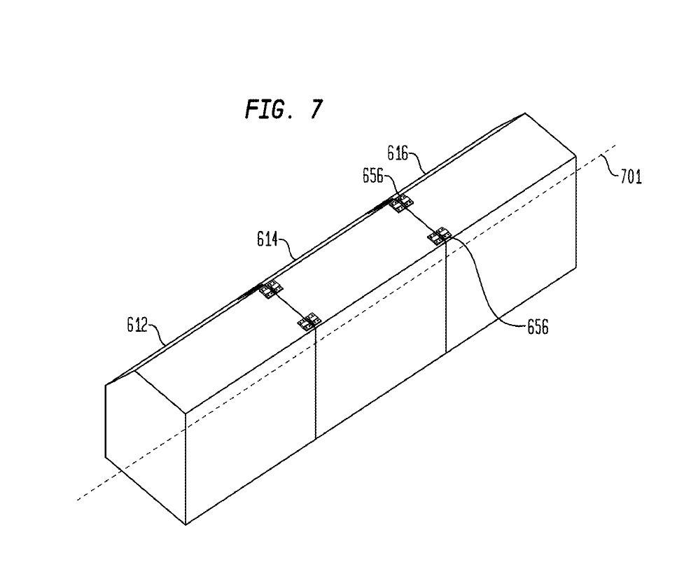

FIG. 7 depicts the attachment of a module 612 and 616 to module 614. It is noted while FIG. 7 depicts three modules, more or fewer modules may be attached to one another.

Details of some exemplary coupling arrangements will now be described.

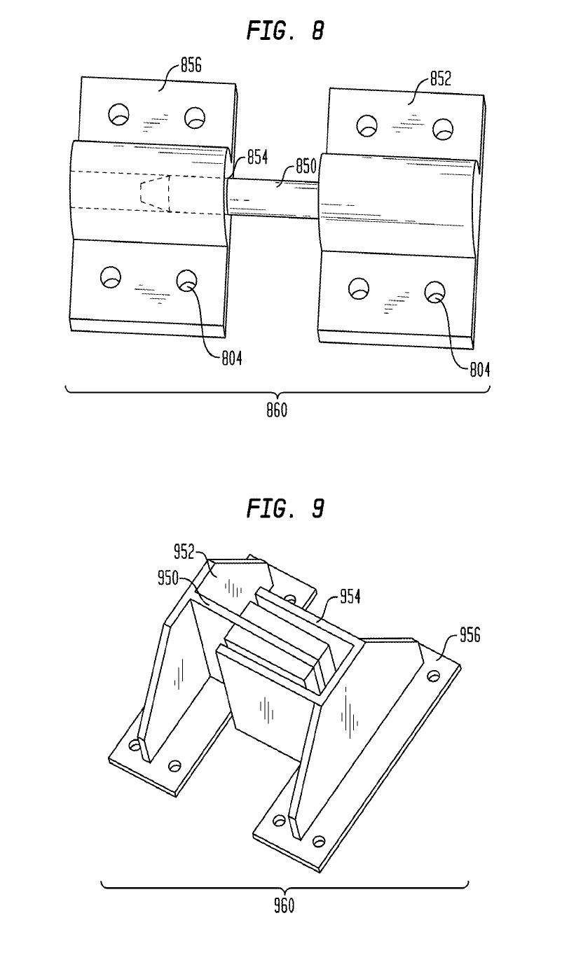

FIG. 8 depicts a pin 850 corresponding to pin 650 and a bracket 852 corresponding to bracket 652. Holes 804 are located through bracket 852. In use, bracket 852 may be bolted or riveted, etc., to the wall structure of the modules, thereby securing pin 850 in place. FIG. 8 further depicts bracket 856 corresponding to bracket 656, which includes bore 854 corresponding to bore 654. As with bracket 852, bracket 856 includes holes 804 located therethrough to facilitate attachment to the walled structure in a manner analogous to the attachment of bracket 852. Collectively, the brackets, bore and pin form a coupling arrangement 860.

The coupling arrangement 860 is configured to permit the modules to move in the longitudinal direction (i.e., a direction parallel to longitudinal axis 701 of FIG. 7 or the other longitudinal axes of the modules detailed herein) while preventing movement in other directions, such as directions lying on a plane parallel to the longitudinal axis. Accordingly, application of the coupling arrangements 860 to system 110, for example, permits expansion and contraction of the system vis-à-vis a change in the relative location of one module to another module while also enabling the distribution of a load applied to one module amongst two or more modules.

FIG. 9 conceptually depicts an alternate arrangement of a coupling arrangement 960. Brackets 952 and 954 support Male Lateral Restraint 950 (a male portion) and Female Lateral Restraint 954 (a female portion), respectively.

As with coupling arrangement 860, coupling arrangement 960 is configured to permit the modules to move in the longitudinal direction (i.e., a direction parallel to longitudinal axis 701 of FIG. 7 or the other longitudinal axes of the modules detailed herein) while providing structural support/preventing movement in a direction normal to the longitudinal direction. That said, while the embodiment of coupling arrangement 860 provides structural support/prevents movement in all directions normal to the longitudinal direction, the embodiment of coupling arrangement provides little, if any, support/permits movement in directions parallel to the channel formed by the female portion (and does the opposite in the direction perpendicular to the channel formed by the female portion). Accordingly, application of the coupling arrangements 960 to system 110, for example, permits expansion and contraction of the system vis-à-vis a change in the relative location of one module to another module while also enabling the distribution of a load applied to one module amongst two or more modules. By placing the couplings 960 on different walls such that their orientations are normal to one another, structural support/prevention of movement can be globally obtained in both directions because individual couplings 960 address a given direction.

It is noted that while the coupling arrangements of FIGS. 8 and 9 do not include a longitudinal direction travel limiting device (i.e., the pin is completely free to be pulled out of the bore), in other embodiments, the coupling arrangements are configured with such a device so as to limit longitudinal travel of the modules relative to one another. Alternatively or in addition to this, other devices delta to the coupling arrangements may provide such travel limiting features.

In an exemplary embodiment, the aforementioned couplings can be used to reduce sheer strain of adjacent modules in addition to or as an alternative to the load distribution/sharing detailed above.

In view of the above, in an exemplary embodiment, there is a module, such as module 614, of a transportable segmented enclosure system, such as system 110, including a first walled structure encompassing a first volume and having a first longitudinal axis. The module further includes a first coupling component, such as a component that includes pin 650 attached thereto. The first walled structure of the module 614 is configured to couple to a second walled structure (e.g., that of an adjacent module) encompassing a second volume and having a second longitudinal axis via interface of the first coupling component (e.g., a component that includes pin 650) with a second coupling component (e.g., a component that includes bore 654) of the second walled structure such that the respective longitudinal axes are at least about parallel to one another and the volumes are proximate one another. In an exemplary embodiment, the aforementioned coupling components are configured such that, when interfacing with one another to achieve the coupling (e.g., the pin 650 is in the bore 654), the first walled structure can move relative to the second walled structure in a direction at least about parallel to the first longitudinal axis.

In an exemplary embodiment, the coupling components are configured such that, when interfacing with one another to achieve coupling (e.g., the pin 650 is in the bore 654), the first walled structure can move relative to the second walled structure a distance of at least about 2 inches in a direction at least about parallel to the first longitudinal axis and is restrained from moving a second distance in direction normal to the longitudinal axis that is greater than about 0.03 inches. Alternatively or in addition to this, in an exemplary embodiment, the coupling components are configured such that, when interfacing with one another to achieve the coupling, the first walled structure can move relative to the second walled structure a first distance in a direction at least about parallel to the first longitudinal axis and is restrained from effectively moving in any direction normal to the longitudinal axis. This owing to the formation of at least almost a slip fit between the pin and the bore. In this regard, in an exemplary embodiment, the pin is about ½ inch in diameter, and the bore has a diameter slightly larger by an amount that will enable the teachings detailed herein and/or variations thereof to be practiced in a utilitarian manner. In an exemplary embodiment, the pin is about ¾ths of an inch diameter, and the bore has a diameter larger by an amount that will enable the teachings detailed herein and/or variations thereof to be practiced in a utilitarian manner.

Alternatively or in addition to the use of the above-mentioned coupling arrangements to “strengthen” adjacent modules, some embodiments include localized structure to strengthen such modules. It is noted that application of such localized structure to one module can have a strengthening effect in a corresponding module when, for example, the modules are connected together utilizing the above-mentioned coupling arrangements.

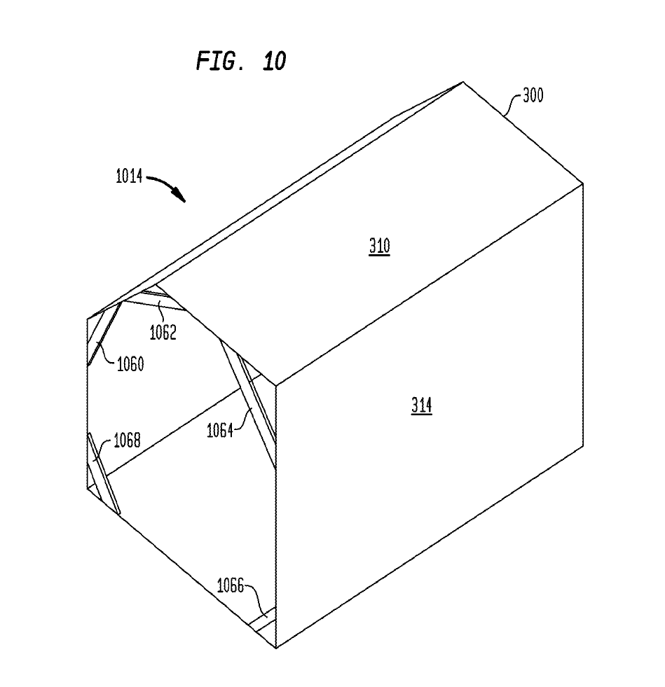

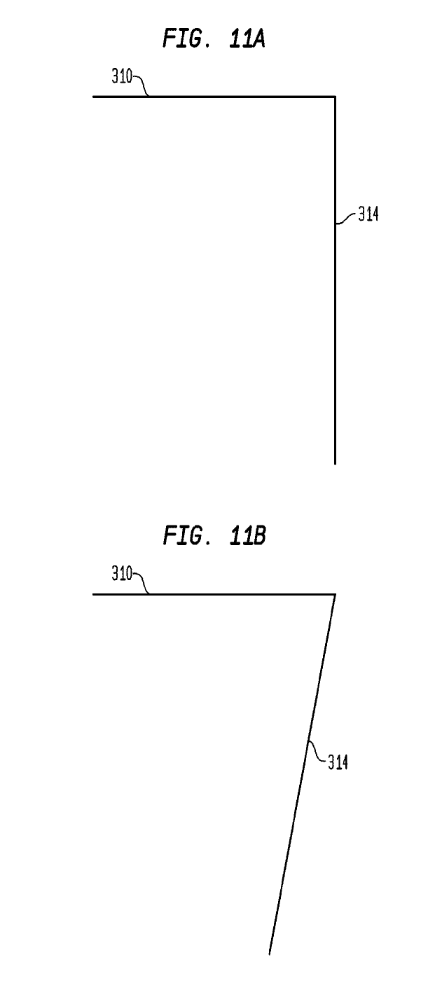

FIG. 10 depicts an exemplary module 1014 having such bracing. Specifically, module 1014 includes wall structure 300 of module 114 (see FIG. 3). Added to that module are braces 1060, 1062, 1064, 1066 and 1068 as may be seen. It is noted that the term “brace,” as used herein, encompasses gussets and other types of structure. These braces are configured to resist movement of a wall structure relative to another wall structure due to a shear stress applied to one or more of the walls. By way of example, a shear stress applied to wall 310 can tend to displace the walls as depicted in an exaggerated form with respect to FIG. 11A and FIG. 11B, where FIG. 11A is the normal, unstressed wall configuration of wall 310 and wall 314, and FIG. 11B is the stressed wall configuration of wall 310 and wall 314, in the absence of brace 1064. In an exemplary embodiment, the addition of brace 1164 will at least limit this displacement.

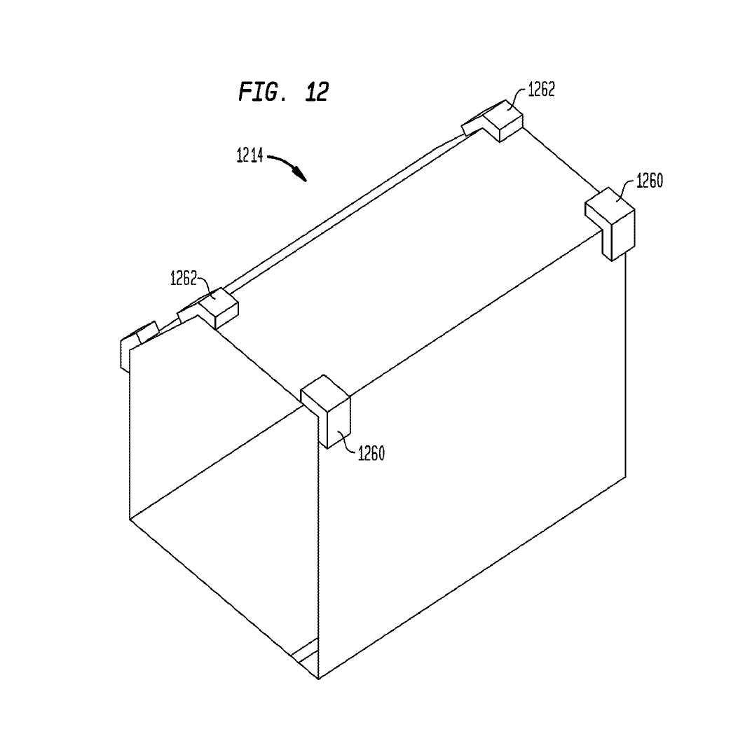

The braces of FIG. 10 have been depicted as beams, although, as noted above, braces may instead be gussets. The beams may have a rectangular (including square and non-square) cross-section and/or a circular cross-section or other cross-section. Further, these beams are located on the interior of the module 1014. However, in an alternate embodiment, one or more or all of the beams may be located on the outside. Moreover, instead of beams, abutment structures may be utilized, such as that shown in FIG. 12, which depicts a module 1214 that includes wall structure 300 and abutments 1260 and 1262. In an embodiment, a combination of beams and abutment structures may be utilized, inside and/or outside the module. Abutment structures can include gussets on the outside of the modules. Any device, system and/or method of bracing the walls of the module to resist movement of one wall relative to another due to a shear stress applied to a wall may be utilized in some embodiments.

Accordingly, in an exemplary embodiment, there is a module, such as module 1014, of a transportable segmented enclosure system, such as system 110 that comprises a first walled structure (e.g., structure 300) encompassing a volume having a longitudinal axis, The first walled structure has a first wall (e.g., wall 310) and a second wall (e.g., wall 314) extending in a plane that is not parallel to that in which the first wall extends (e.g., a plane formed by wall 314, which would be normal to the floor of the module and parallel to the longitudinal axis of the module). The first walled structure further includes a first brace, such as brace 1064, configured to resist movement of the first wall 310 relative to the second wall 314, or visa-versa, due to a shear stress applied to one of the first and second walls. In an exemplary embodiment, the first brace 1064 is coupled to the first wall 310 and the second wall 314, the first brace 1064 being configured to resist a shearing force applied to one of the first wall 310 and the second wall 314.

In an exemplary embodiment, the aforementioned brace (e.g., brace 1064) resists movement of corresponding walls (e.g., walls corresponding to walls 310 and 314) of an adjacent module when, for example, the modules are coupled using the couplings detailed above.

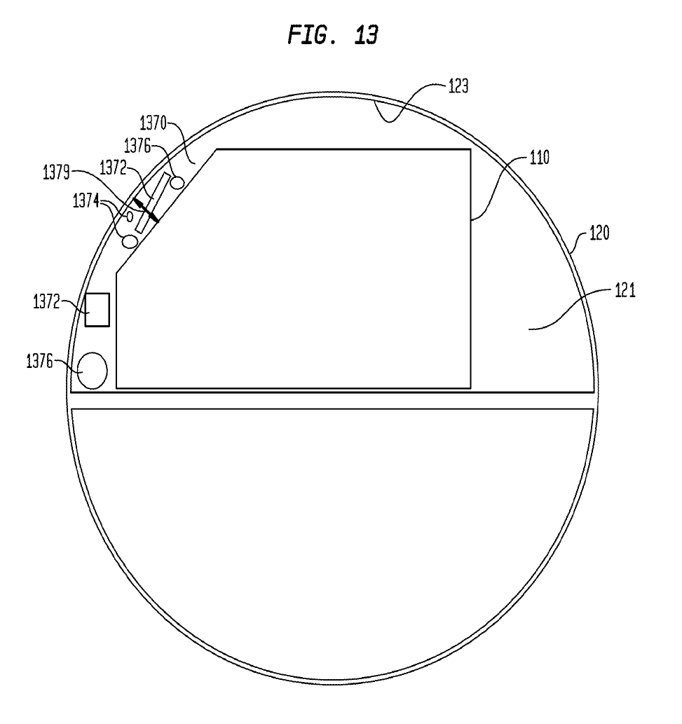

As may be seen from the above FIGs., the modules of the enclosure system 110 have an outer profile lying on a plane normal to a floor of the module (e.g., the plane of FIG. 2A), includes an outer profile having a compound shape. While the embodiment of system 110 is such that all modules include such a compound shape (which can be different from module to module or can be the same), other embodiments may not have all modules with such a compound shape. Accordingly, an exemplary embodiment includes an overseas vehicle, such as aircraft 120, and a system including a module having the compound shape, in which components are placed in the recess of the compound shape. FIG. 13 depicts such an exemplary embodiment. As may be seen, aircraft 120 includes an interior 121 which includes an interior boundary 123. This interior boundary envelopes the outer profile of the module of system 110, owing to the fact that it is placed in the aircraft 120. Utility conduit is located in the recess 1370 between the interior boundary 123 and the outer boundary of the module. For example, utility conduit 1372 may be an HVAC duct. Other utility conduits located in this space include potable water supplies 1374 (hot and cold water) and/or electrical lines 1376. Additional conduits may include communication wiring.

FIG. 13 also depicts conduits 1372 and 1376 being located between the system 110 and the interior boundary 123, although outside the recess 1370 of the compound shape.

It is noted that while not shown in the figures, utility conduits can be located in the space directly above the module ceiling (in between the ceiling and the interior boundary 123).

It should be appreciated that alternate embodiments that have utilitarian value with respect to the utility conduits may be implemented. In one such an exemplary embodiment, a utility conduit may be included in enclosure system 110. In an exemplary embodiment, the conduits extend along the longitudinal axis of the modules, and include couplings so that the conduits of one module can be connected to the conduits of another module. In an exemplary embodiment, one or more of the modules includes connectors to connect the utility conduits to the aircraft utility, although in some embodiments, the utility conduits are ultimately connected to a source of utility in a module (e.g., and not connected to aircraft utility). In such a manner, the modules may be placed into utility communication with one another.

In an exemplary embodiment, a distance 1379 in a direction normal from a surface at the location of the enclosure that results in the existence of the compound shape to the interior boundary is about 15, 16, 17, 18, 19 20, 21 and/or 22 inches.

It is noted that the aforementioned spaces may include additional components in addition to or as an alternate to utility conduits.

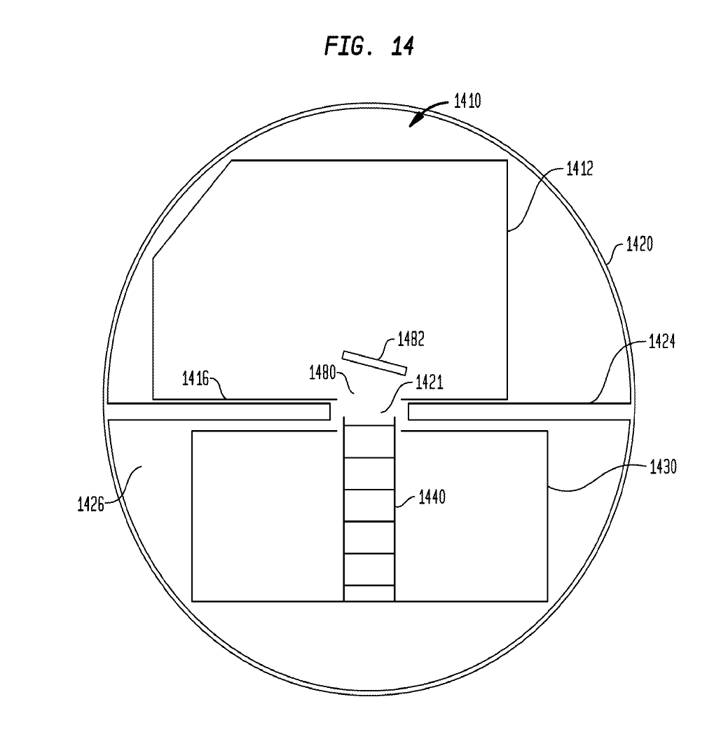

FIG. 14 depicts a cross-sectional view through an aircraft 1420 and a system 1410 according to an exemplary embodiment. System 1410 corresponds to system 110 detailed above, with the addition of a feature to one or more of the modules of a hole through the floor thereof. Particularly, FIG. 14 depicts a module 1412 corresponding to any of the modules detailed above, although in this particular embodiment, it corresponds to module 112 (the most forward module) that includes wall 416 that serves as a floor (hereinafter, sometimes referred to as a floor segment). In an exemplary embodiment, the forward module (module 112) need not be maintained in as clean a state as other modules, and thus the presence of hole 1480 when floor panel 1482 is removed does not have an effective impact on the performance/utility of system 1410.

Hole 1480 permits access from the interior of module 1414 to hole 1421 in deck 1424 and thus into below-deck area 1426. In an exemplary embodiment, a ladder 1440 is positioned proximate hole 1421 so as to enable at least a fifty percentile human male to climb from the below-deck area 1426 into the interior of module 1412 and visa-versa.

It is noted that the embodiment of FIG. 14 depicts a separate module 1430 located beneath deck 1424, although in other embodiments, a separate module may not be located below deck 1424. Further, it is noted that while no seal is depicted between module 1412 and module 1430, in an exemplary embodiment, there is a sealed passageway between the two.

The embodiment of FIG. 14 permits consumables and/or equipment to be stored below deck 1424 and then directly brought into system 1410 when needed and visa-versa. As noted above, an embodiment of the system 110 includes a system that is utilized in conjunction with surgical operations and/or other medical procedures. In this regard, in an exemplary embodiment, there is a system 110 that includes an operating room. The operating room may be configured to one module, or may extend between two or more modules. Other modules may include observation room(s), medical supply management (e.g., cleaning) room(s), recovery room(s), etc. An exemplary embodiment includes a system 110 that enables a human patient to be transported horizontally on a table having a length and width of about 6 feet and 2.5 feet, respectively, from one module to another without leaving the system 110 all the while the system 110 maintains the enclosure between the outside of the system and the interior of the system.

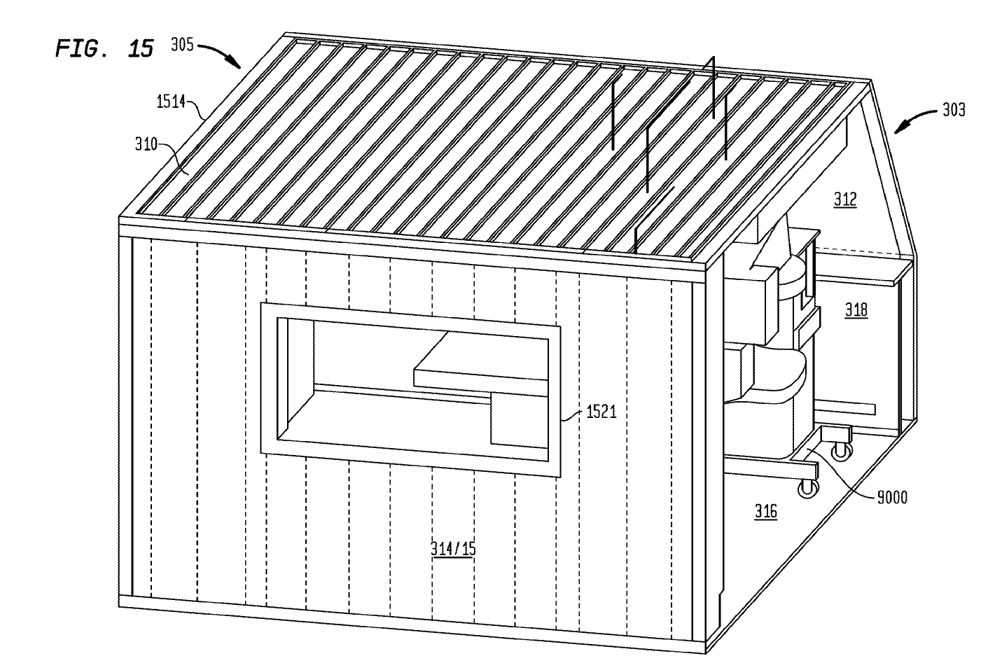

FIG. 15 depicts an exemplary module 1514, which generally corresponds to module 114 of FIG. 3 and is usable in system 110. FIG. 3 depicts the module 1514 from a different perspective than that of module 114 depicted in FIG. 3. Similar structure between module 114 and 1514 is referred to utilizing the same reference numbers. Exemplary module 1514 forms a portion of an operating room used, for example, for surgery (e.g., eye surgery) or other medical procedures, as evidenced by the wheeled gurney 9000 (which is not part of the module 1514, but instead depicts an exemplary use of the module). As can be seen, wall 31415 includes a window 1521 permitting observation from outside the module 1514/system 110 (e.g., to observe the surgery taking place inside the module 1514. Window 1521 may be glass or plexiglass or another transparent material that enables the enclosure features detailed herein and/or variations thereof to be practiced.

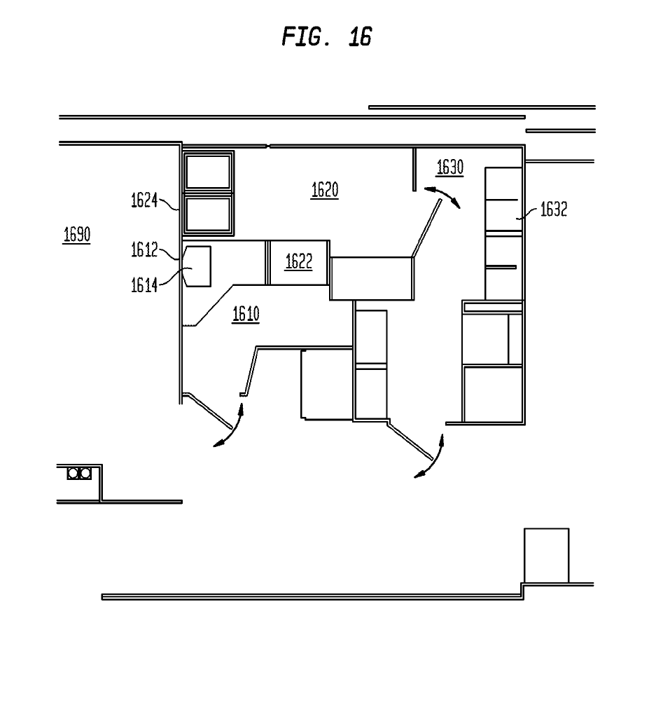

An exemplary embodiment of system 110 may include a medical supply management facility (MSMF). In an exemplary embodiment, such a medical supply management facility is contained in a module (taking up the entire volume of the module or only a portion of the volume), while in an alternate embodiment, the medical supply management facility extends from one module into another module (or more). FIG. 16, depicts an exemplary floor plan of such a module.

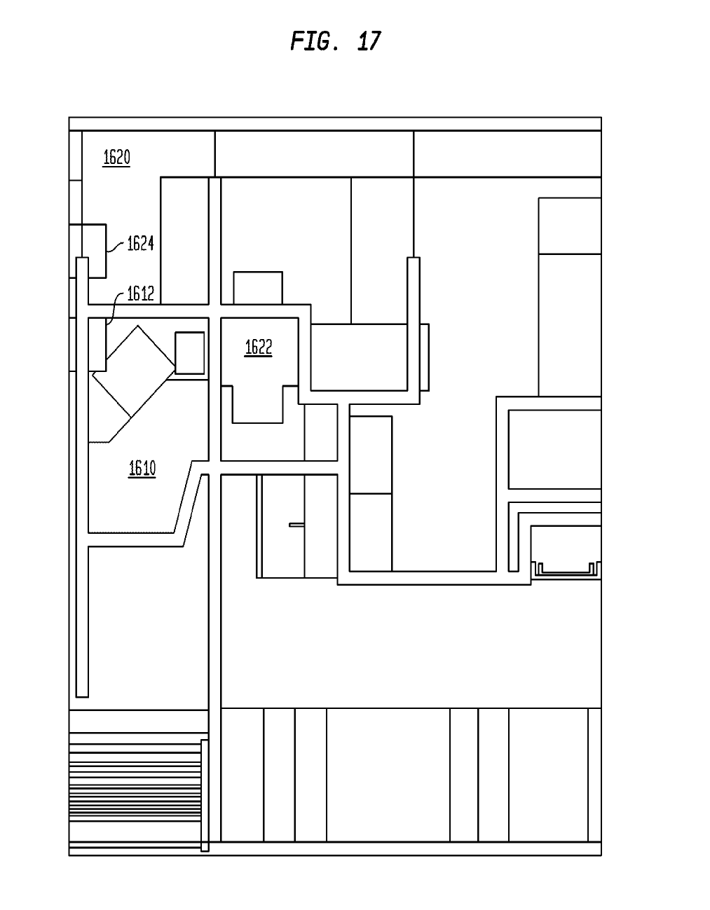

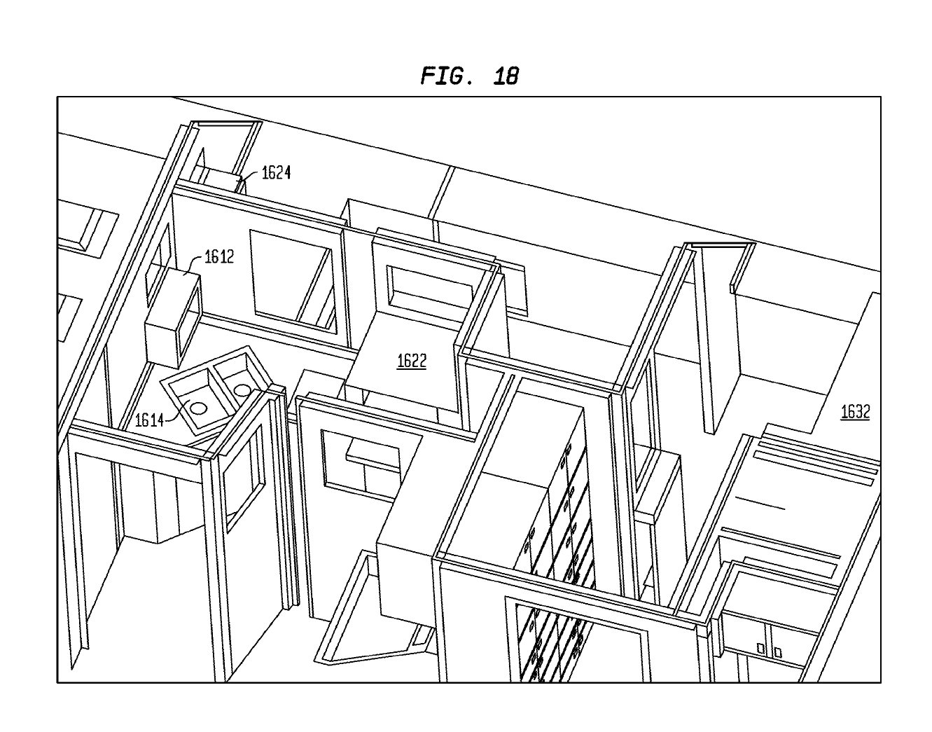

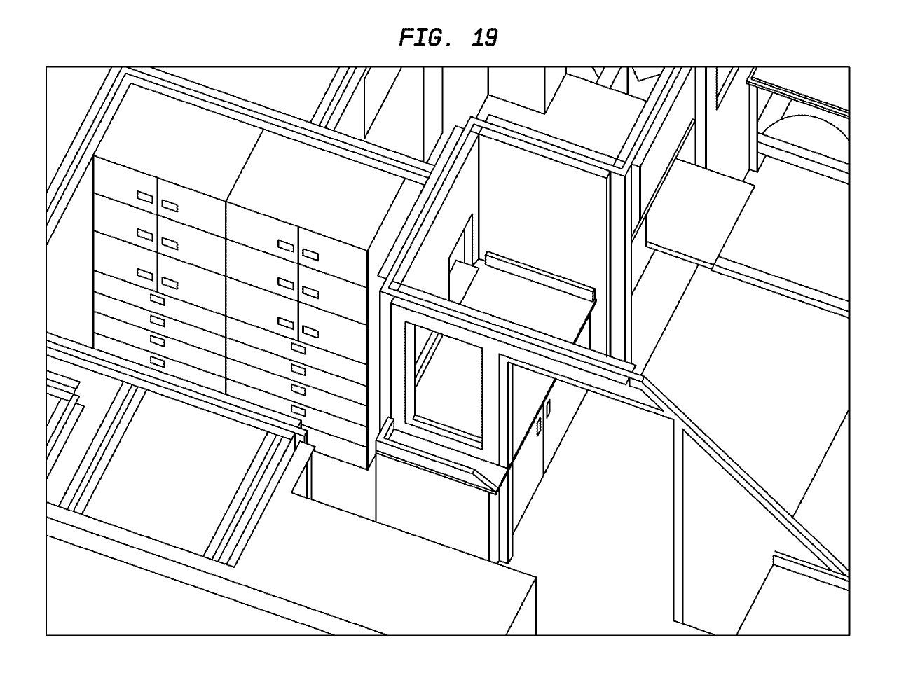

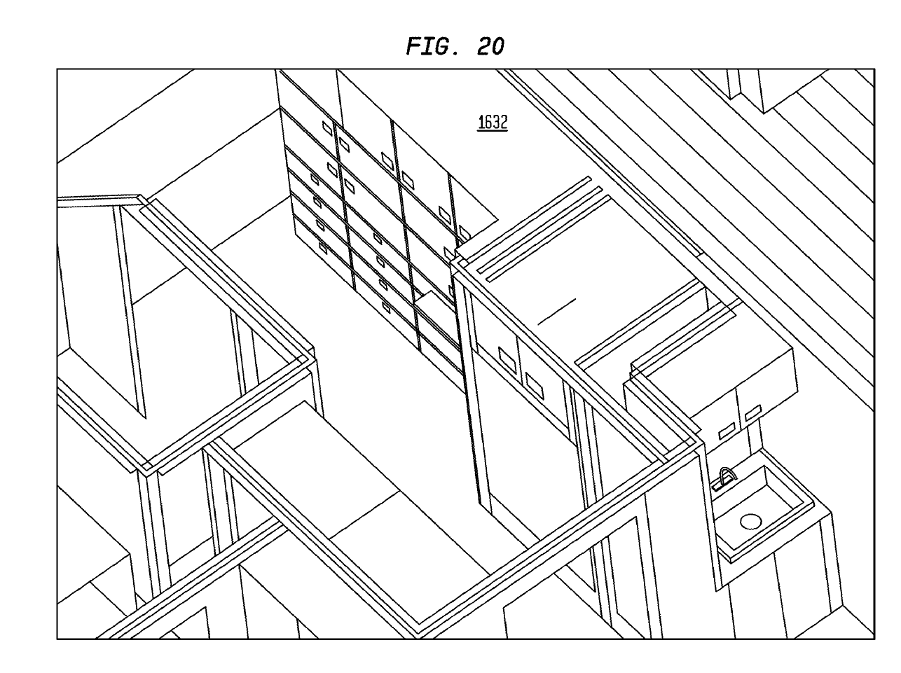

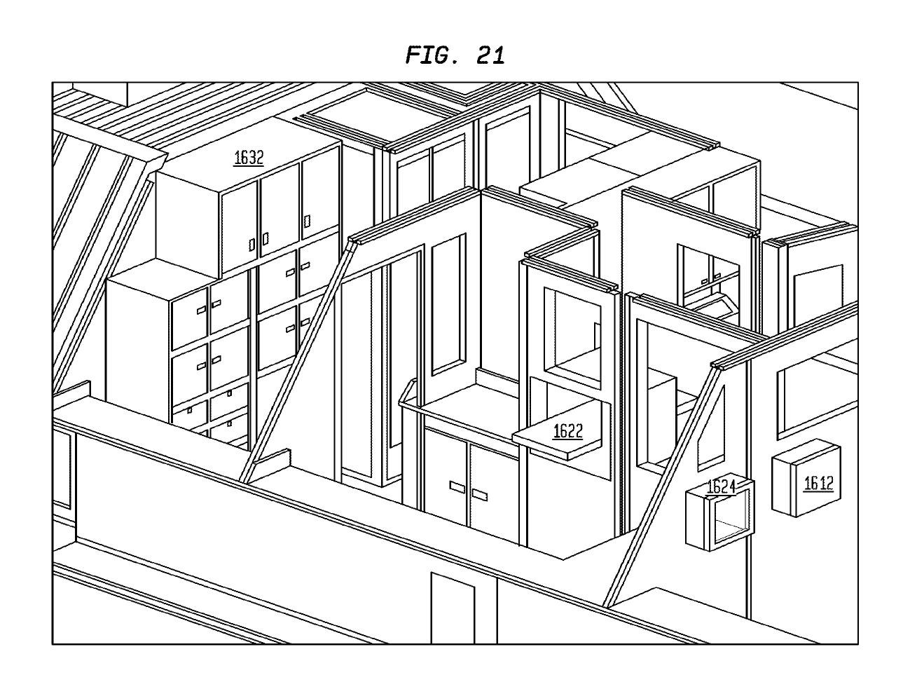

More particularly, FIG. 16 includes a floor plan that may be located in one or more modules. The floor plan represents a top-view of components (walls, doors, countertops, etc.) FIGS. 17-22 depict the features of the MSMF from different views installed in an aircraft (FIG. 17 is a top-view, FIG. 18 is a perspective view looking from the top left side of the aircraft in a slightly forward direction, FIG. 19 is a perspective view looking from the top slightly on the right of the aircraft slightly forward, FIG. 20 is a perspective view looking from the top slightly on the left side of the aircraft slightly backward, FIG. 21 is a perspective view looking from the top right side of the aircraft slightly backward, FIG. 22 is a perspective view looking from the top slightly on the left side of the aircraft looking slightly forward.

Referring back to FIG. 16, the MSFS includes a soiled side section 1610, a clean side section 1620, and a store room 1630. These sections are not hermetically sealed from one another in some exemplary embodiments, while in others, such is the case. The sections are established more for demarcation purposes (e.g., the user assumes that any medical supply in the soiled side 1610 is soiled and any medical supply in the clean side 1620 is clean, etc.).

In an exemplary embodiment, soiled medical supplies (e.g., forcept, scalpel, etc.) is moved from, from example, an operating room/facility 1690 (which may be immediately forward the MSMF) into the MSMF soiled side 1610 through portal 1612. Portal 1612 may include slide doors/windows to establish an enclosure between the operating room and the MSMF. The soiled medical supplies, once in the soiled side section 1610, are cleaned in sink 1614 (e.g., blood, tissue, etc., is removed through the use of water, soap, etc.). After cleaning, the now clean medical supplies are moved from the soiled side 1610 into the clean side 1620 through portal 1622 (which again may include an enclosure as with portal 1612). In the clean side 1620, the now clean medical supplies are sterilized and put into packaging (sterilization may take place before or after placement into the packaging). The now packaged medical supplies are either delivered from the clean side 1620 into the operating room 1690 through portal 1624, or placed into storage in storage room 1630 (e.g., in shelves 1632) so that it can be retrieved for later use.

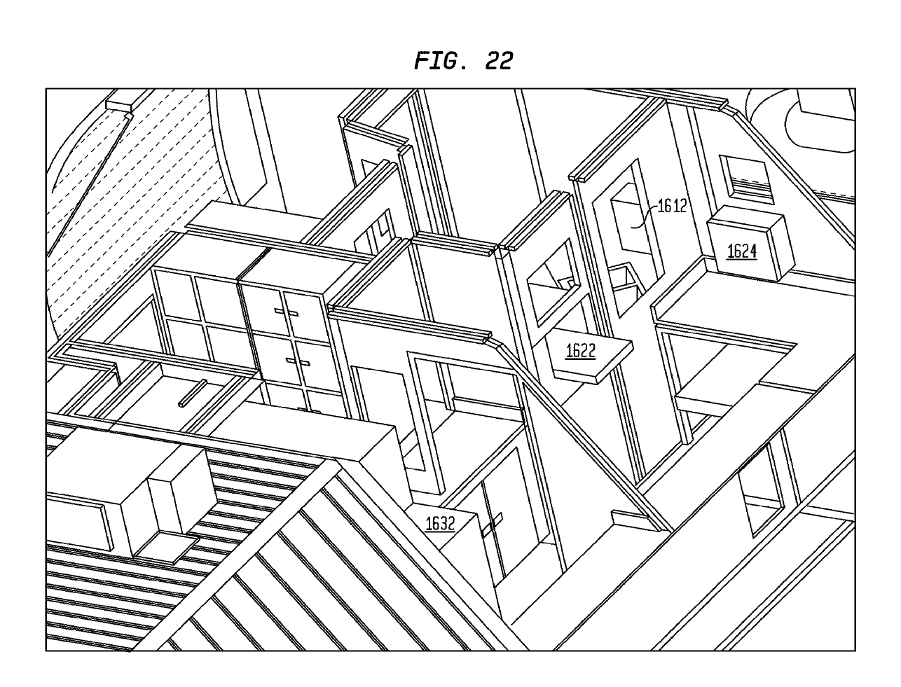

While embodiments detailed herein have typically been directed towards establishing an environmental barrier in an overseascraft, alternate embodiments may be practiced where such an enclosure is not established, but some and/or all other teachings detailed herein are utilized. In this regard, while embodiments detailed herein are typically directed towards a group of modules that, when connected as detailed herein, forms an enclosure, in some embodiments, an enclosure is not established. For example, a module may be open, the module being configured to support equipment or the like in a manner that would otherwise, without the teachings detailed herein, require the recertification of the aircraft with the FAA. FIG. 23 depicts an exemplary embodiment of a module 2314 that is open that is used as part of a machines shop system that may be established inside the overseascraft, with element 2398 being a lathe and element 2399 being an over-head hoist. As may be seen, braces 2320, 2322 and 2324 are added to provide structural rigidity to the walled structure of module 2314.

As will be recognized from FIG. 23, some modules in some embodiments are configured to support equipment and other objects (e.g., cabinets, lights, batteries, HVAC units) from the walls. It is noted that while module 2314 is depicted in FIG. 23 as a module of an open system (that is not used to establish an environmental barrier), in other embodiments, such as, for example, any of the embodiments detailed above and/or variations thereof, the modules are likewise used to support equipment and other objects from the ceiling walls and/or the sidewalls. (An alternate exemplary embodiment of module 2314 is part of enclosure system (e.g., an extra sidewall is added to the module depicted in FIG. 23).) Accordingly, modules in some embodiments are substantially rigid structures. For example, in some exemplary embodiments, the walled structure making up the module is substantially more rigid than, for example, the walled structure making up aircraft cargo containers which would otherwise be located where the modules are located when the aircraft is utilized as a cargo aircraft.

Accordingly, an exemplary embodiment includes a module including a walled structure that is sufficiently rigid to mount equipment and/or other objects to the sidewalls and/or the walls forming the celling thereof. In an exemplary embodiment, the module is configured to support an article having a mass of about 100 kilograms. In an exemplary embodiment, the module is configured to support the aforementioned article in a 1.5 G environment without any substantial deformation and/or without any permanent deformation of the walled structure.

An exemplary embodiment of structure forming a walled structure according to one or more of the embodiments detailed above and/or variations thereof will now be detailed. It is noted that in some embodiments, the following teachings are implemented to achieve the above-referenced load bearing (equipment bearing) features.

In an exemplary embodiment, one or more sidewalls and/or ceiling walls and/or floor walls of the walled structures making up one or more of the modules are made of wall sections that extend in a direction normal to the longitudinal axis of the modules (e.g., with respect to the sidewalls, the sidewalls extend in the vertical direction—hereinafter, the phrase vertical wall section and variations thereof are meant to refer to sections that extend in the direction normal to the longitudinal axis). This as opposed to sections that extend in a direction parallel to the longitudinal axis of the modules (e.g., with respect to the sidewalls, the sidewalls extend in the horizontal direction). The wall sections of the present technology can be assembled into wall panels without the need for mechanical fasteners and in a fashion that allows for expansion and contraction with less likelihood of oil-canning or warping. Fabrication of the wall sections of the present technology can be accomplished with more readily-available equipment and in more readily-available facilities, and can present simpler material handling tasks. Modules assembled from wall built of wall panels using vertical wall sections of the present technology can be more amenable to assembly and offer more flexible routing of utilities than those assembled from horizontal wall sections.

It is noted, however, that some embodiments of the modules detailed herein and/or variations thereof include a walled structure having one or more walls having wall sections that extend in a direction parallel to the longitudinal axis of the modules. In an exemplary embodiment, the walls of a given module may include one or more walls having wall sections extending normal to the longitudinal axis and one or more wall sections extending parallel to the longitudinal axis. Any configuration of wall sections that will enable the fabrication of modules according to the teachings detailed herein and/or variations thereof, such as modules meeting the aforementioned rigidity and structural utilitarian features, may be utilized in some embodiments.

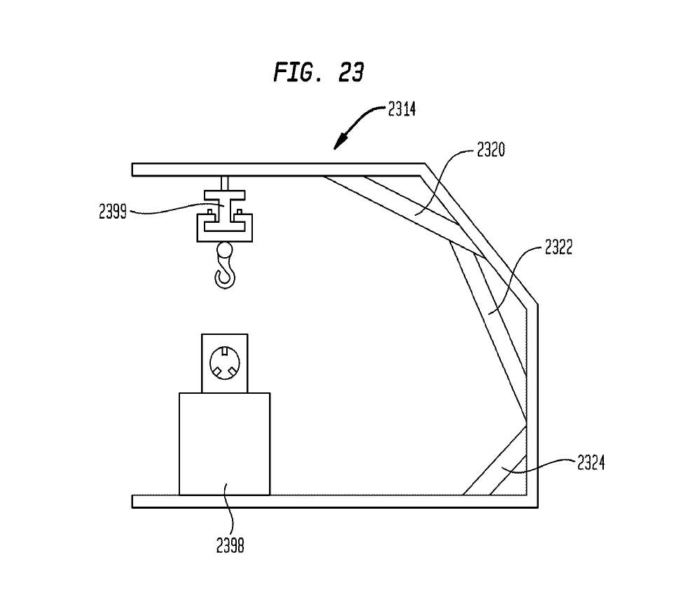

Referring to FIG. 24, a wall section 10000 of the present technology is show in projection. In some embodiments of the technology, wall sections 10000 can be formed from metal sheets, e.g., 3000 series aluminum. In other embodiments of the technology the wall section 10000 can be formed from materials such as plastics, polymers (e.g., fiberglass fiber reinforced polymer), and composites. The wall section includes a main body 11000 of width substantially less than length. For example, the width can be 10″-12″ while the length can be 96″-120″. The wall section profile geometry (section width, overall height), material type, and material thickness can be determined by the structural requirements of the particular application, e.g., a module conforming in overall dimensions to, for example, an ISO container standard, or to another standard. The wall section 10000 can be formed from a sheet of uniform thickness substantially less than the wall main body 11000 width. For example, the wall section 10000 thickness can be 0.080″. The wall section 10000 includes an “L” flange 12000 and a second flange 13000.

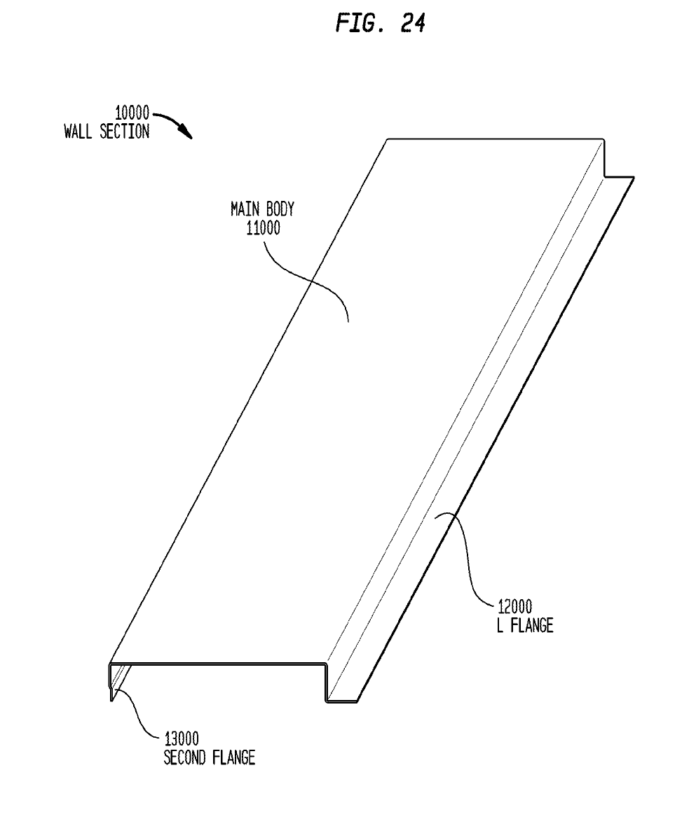

Referring to FIG. 25, in which the wall section 10000 is shown in front and side views, the L flange 12000 includes a perpendicular portion 12200 and a parallel portion 12400, where “perpendicular” and “parallel” are in reference to the wall section 10000 main body 11000. The perpendicular portion 12200 is of width less than the width of the main body 11000, but substantially greater than the material thickness. For example, the perpendicular portion 12200 can be 1.75″ wide. The perpendicular portion 12200 of the L flange 12000 is formed substantially perpendicular to, and (in most embodiments) substantially coextensive with, a first long side of the main body 11000. The parallel portion 124 is of width less than the width of the main body 11000, but substantially greater than the material thickness. For example, the parallel portion 12400 can be 1.5″ wide. The parallel portion 12400 of the L flange 12000 is substantially perpendicular to, formed at, and (in most embodiments) substantially coextensive with the side of the perpendicular portion 12400 not adjoining the main body 11000. The parallel portion 12400 extends away from the main body 11000.

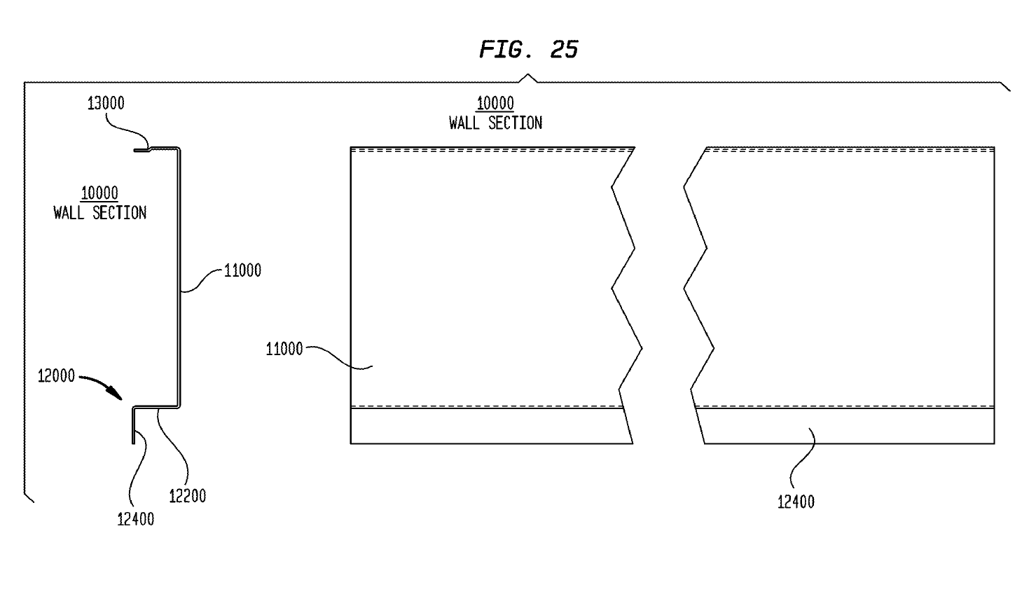

Referring to FIG. 26, the wall section 10000 of the present technology is shown in a side view and in section views illustrating the first flange 12000 and a second flange 13000. The second flange 13000 includes a second flange first portion 13200 and a second flange second portion 13400. The overall width W4 of the second flange 13000 can be substantially equal to the overall width W2 of the L flange 11000, minus the material thickness T. As described below, this relationship can facilitate assembly of wall panels and walls, and allows panels and walls assembled from wall sections to present a substantially co-planar surface on the non-flange side of the wall panels, walls, and modules. For example, the overall width W4 of the second flange 13000 can be 1.670″. The second flange first portion 13200 is formed substantially perpendicular to, and (in most embodiments) substantially coextensive with, a second long side of the main body 11000.

In the illustrated embodiment, the second flange second portion 13400 is an offset portion. The offset portion 13400 can add rigidity to the wall section 10000 when the wall section is subject to end loading, e.g., when the wall section is used as a vertical element in a wall panel. Generally, the second flange portion 13400 can be any portion extends from the second flange first portion generally in the direction of the main body interior, and is not coplanar with the second flange first portion, e.g., as described below in connection with FIG. 4.

Wall section 10000 can be formed by manufacturing methods such as using a press brake on sheet aluminum, to create bends, e.g., bend 14000, and to create the offset between the second flange first portion 13200 and the second flange second portion 13400, thereby avoiding the disadvantages of methods such a roll forming. Bends 14000 are substantially right angle bends along each side of the main body at the L flange 12000 and the second flange 13000, and along the length of the L flange perpendicular portion and the L flange parallel portion. For instance, bends 14000 can be ⅛″ radius bends.

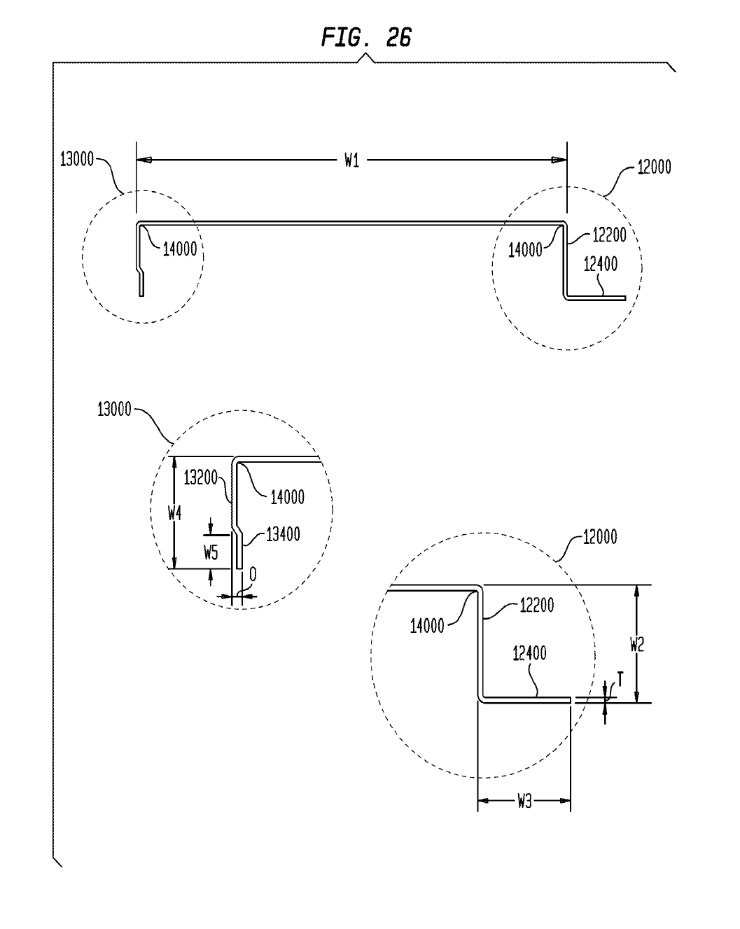

Referring to FIG. 27, an alternative embodiment of the second flange 13000 is illustrated as flange 43000. In this embodiment the overall width W6 of the second flange 43000 can be substantially equal to the overall width W2 of the corresponding L flange 11000, minus the material thickness T. For example, the overall width W6 of flange 43000 can be 1.5″. The flange first portion 43200 is substantially similar to flange first portion 13200. Flange 43000 second portion 43400, instead of being parallel to, but offset from, first portion 43200, is oblique to first portion 43200 at an angle A. The flange 43000 of FIG. 4 can find use in ceiling sections. The embodiment illustrated in FIG. 27 also can find use when mechanical fasteners are used to connect wall sections in to wall panels and walls. In embodiments employing mechanical fasteners for joining wall sections, maximizing the parallel surface area between the surfaces to be connected is not as critical as when adhesives are used.

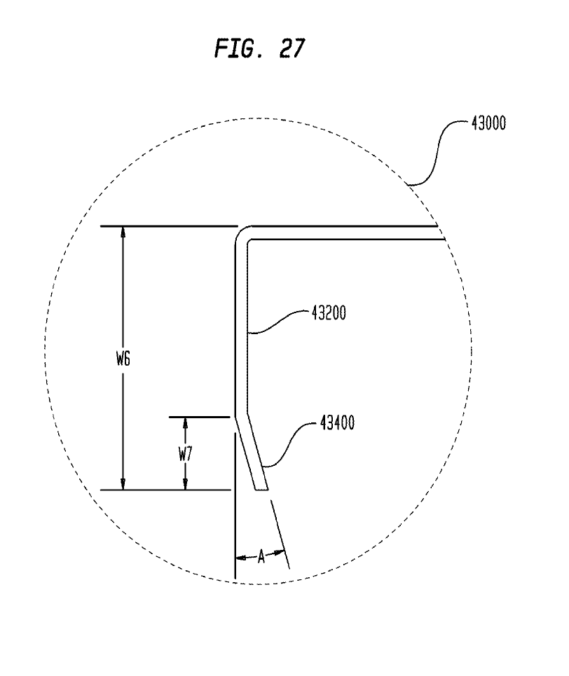

Referring to FIG. 28, an expanded partial cross-section view illustrating a wall panel at the joint between wall sections 10000A and 10000B, each similar to wall section 10000 of FIG. 24, FIG. 25, and FIG. 26, is illustrated. Both wall sections 10000A, 10000B are oriented with flanges in the same direction, i.e., down in FIG. 28.

Spacers 20000 are shown as applied to the exterior surface of the L flange perpendicular portion 12200A corresponding to the exterior of the second flange first portion 13200B. Spacers 20000 also can be applied to the exterior of the second flange first portion 13200B. Preferably, spacers are applied before applying an adhesive, as described below.

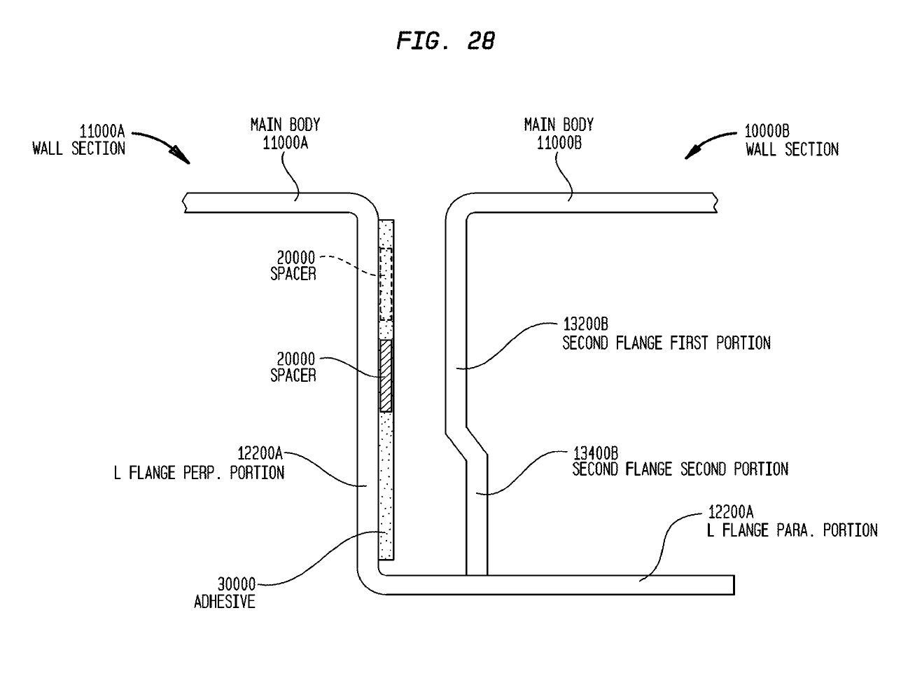

In some embodiments, spacer 20000 is a durable, resilient elastomer that resists drying, rotting, or embrittling, such as Bumpon™ from 3M™. Spacer 20000 can include an adhesive backing, e.g., of acrylic, natural rubber, synthetic rubber. Spacers 20000 can facilitate having uniformly thick bond lines throughout the assembly, and promote regular and uniform curing of the adhesive that is desirable for final assembly of the sections into panels and panels into walls. Preferably, spacer 20000 has a high coefficient of friction to resist skidding on most surfaces. Preferably, spacer is of width on the order of magnitude of 1″ (with 3/16″ squares being preferred), and of thickness to maintain separation between the upper portion of wall section L flange 12000A and wall section second flange first portion 13200B. The separation is determined by that distance desired to allow adhesive 30000 to properly bond wall section 10000A to wall section 10000B. In some embodiments, the thickness of spacer 20000 is 0.030″. While FIG. 28 illustrates a vertical distribution of spacers 20000, and FIG. 29, described below, illustrates longitudinal distribution of the spacers, various other distributions are possible to facilitate proper bonding between the wall sections using the adhesive 30000.

Adhesive 30000, while shown in FIG. 28 as uniformly distributed, can be applied in one or more beads around the spacers on one or both of the surfaces to be joined, as known to those of skill in the relevant art. In some embodiments, adhesive 30000 is a single component, high strength, elastomeric sealant. For example, Hybrid adhesive sealant 76000 from 3M™. The adhesive 30000 is applied in sufficient quantity to substantially fill the space between the second flange first portion 13200B of wall section 10000B to the depth of the spacer 20000.

The use of spacers and adhesive may allow a wall panel, and walls and other structural elements built therefrom, to expand and contract with less stress on the wall section than in other panel and wall configurations.

Referring to FIG. 29, the cross-section view of FIG. 28 is seen from a top view. In this view it can be seen that the spacers 20000 are distributed along the joint between wall section 10000A and wall section 10000B. In assembling a wall panel from wall sections, sections 10000A and 10000B are brought together and clamped for sufficient time to allow the adhesive to bond the sections together. Excess adhesive 40000, e.g., adhesive beyond that needed to substantially fill the gap between wall section 10000B second flange first portion 13200B will flow 1) into the space between wall section 10000B second flange second portion and the corresponding portion of wall section 10000A first flange perpendicular portion 12200A, and 2) out of the top of the joint. Adhesive 40000 flowing out of the top of the joint can be removed.

This adhesive joint can expand and contract with changes in temperature more readily than the wall sections can. This property gives a module or container built using wall, ceiling, or floor elements in accordance with the present technology an advantage over the same structures assembled with fasteners such as rivets, screws, clips, welding, and nuts and bolts.

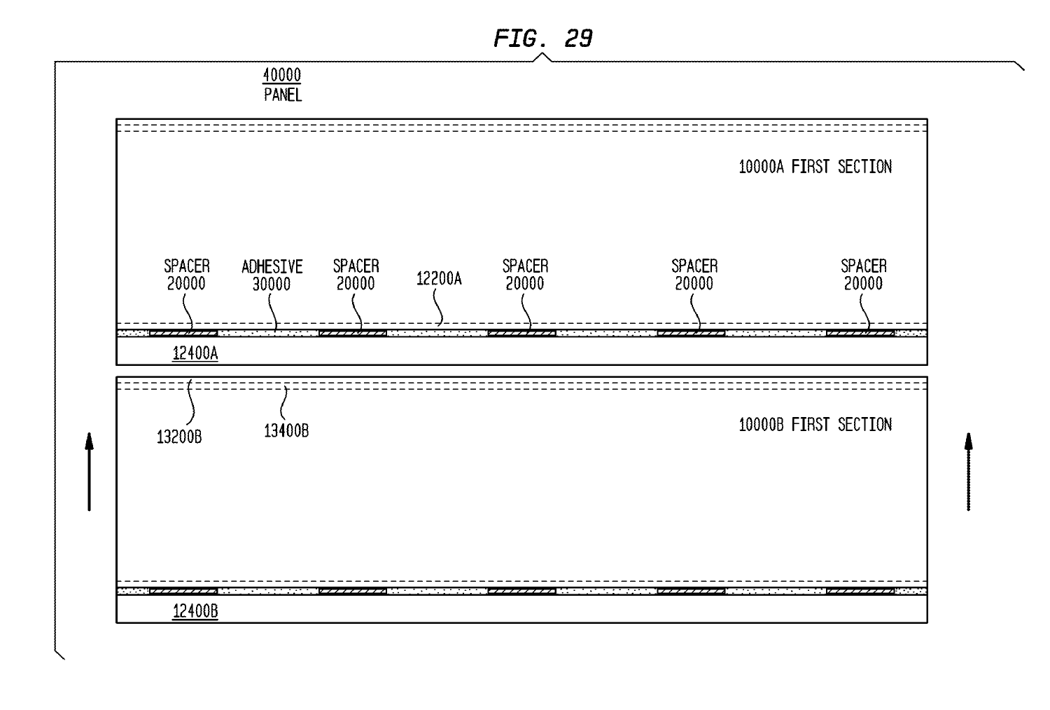

Referring to FIG. 30, a flow chart describing methods 70000 for assembly of wall panels from wall sections is shown. In step 71000, a plurality of wall sections 10000 are formed (Step 71000). For example, wall sections 10000 are formed from aluminum sheets using a press brake for bending both an L flange 12000 and a second flange 13000 into the sheet. For the purpose of this example, three (3) wall sections are formed and aligned with long sides parallel; each wall section oriented as shown in FIG. 24—with the L flange on the right and the second flange on the left, both flanges facing down.

For the leftmost and center wall sections, spacers, such as spacers 20000, are affixed to the L flange perpendicular portion 12000 at a position corresponding to the mating second flange first portion 13000 of the next wall section (Step 72000), e.g., as shown in FIG. 28 and FIG. 29. Adhesive, e.g., adhesive 40000, is applied to the L flange perpendicular portion 12000 at a position corresponding to the mating second flange first portion 13000 of the next wall section around the spacers (Step 73000). Preferably, sufficient adhesive is applied to substantially fill the space between the L flange perpendicular portion 12000 and the mating second flange first portion 13000 of the next wall section.

The three wall sections, now joined by spacers and adhesive into a wall panel, are now clamped together, and the panel is allowed to cure (Step 74000).

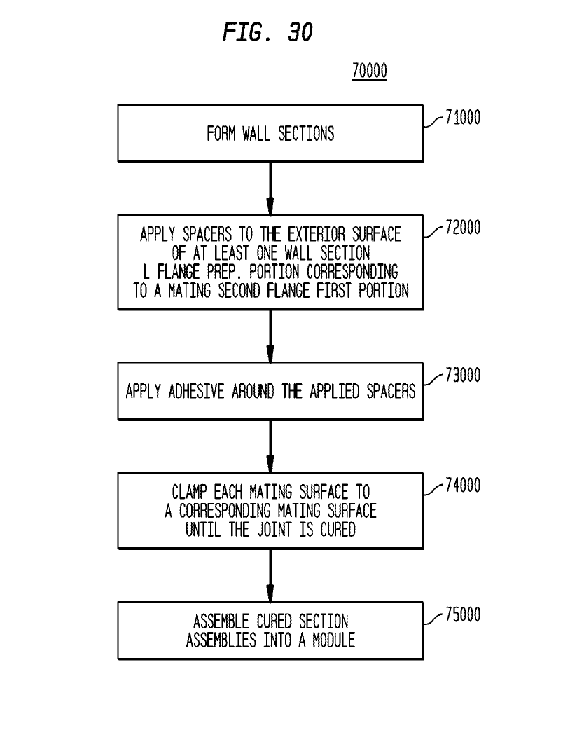

Referring to FIG. 31, a wall panel 800 of the present technology is illustrated. In FIG. 31, the wall panel 80000 includes three (3) wall sections 10000, and a partial wall section 91000. Partial walls sections can be used when wall length is desired to be other than a multiple of the wall section length. In some embodiments of the technology, a partial wall section is, as shown in FIG. 8, simply a wall section 10000 terminated before reaching either the L flange or the second flange. In some embodiments, a partial wall section includes both an L flange and a second flange as described above, but has a main body width different than the main body width of other wall sections used in a panel.

FIG. 31 also illustrates the L flange parallel portion 12400, including the L flange parallel portion outer face 92000. In some embodiments, the L flange parallel portion extends only as far as required to contact the second flange second portion 13400 of the adjoining wall section. In other embodiments, such as the embodiment shown in FIG. 8, the L flange parallel portion extends beyond the second flange second portion 13400, providing a broader L flange parallel portion outer face that can be used to secure other structural elements (such as horizontal rails) and finish elements (such as wall board). The space 93000 that can be enclosed by finish elements such as wallboard can be used to route utilities (e.g., electrical, communications), water, medical gases, and heating, ventilation, and air conditioning (HVAC) elements.

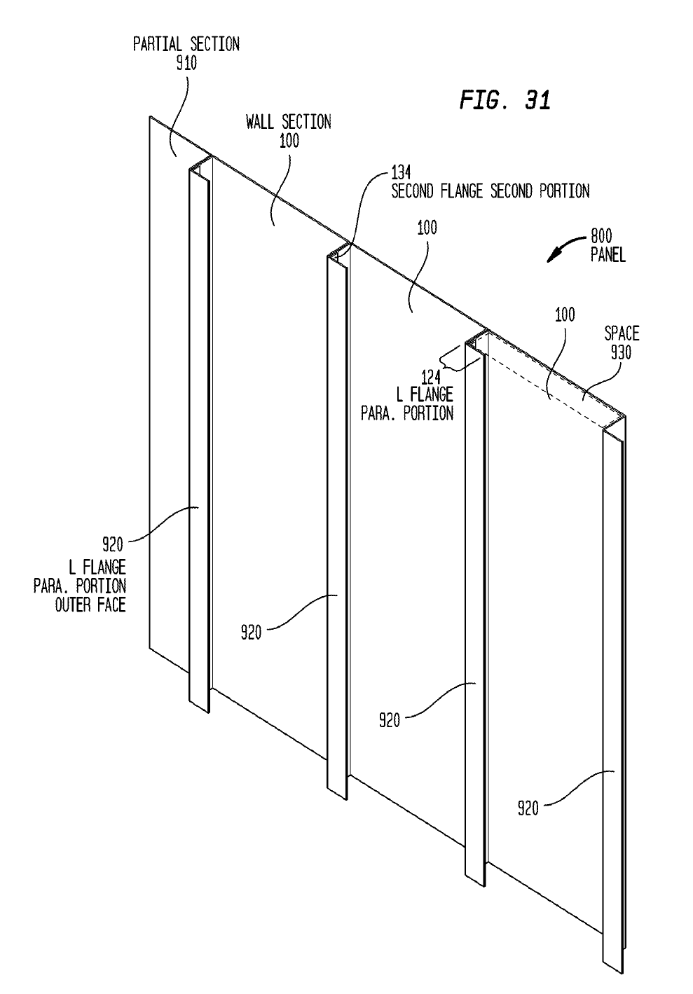

Referring to FIG. 32, a wall 99000 of the present technology is illustrated. Wall 99000 is not shown to scale; features are exaggerated to illustrate the relationship between the elements of the wall 99000. Wall 99000 can include a plurality of wall panels 80000. Typically, wall 99000 can include ten (10) or more wall panels 80000; each wall panel 80000 can include a number of wall sections 100, e.g., three (3) full-width wall sections 10000 and one (1) partial-width wall section as shown in FIG. 8. In preferred embodiments, walls 99000 are formed with wall sections 10000 of the wall panels 800 oriented vertically, e.g., along the short dimension of the rectangular wall 99000 for configurations in which the wall 99000 is longer than it is high.

The wall panels 80000 can be held in a frame built from frame segments 99200, with the flange side of each wall section 10000 facing the interior, thereby presenting a substantially co-planar surface to the exterior. The frame can form a recess, as shown in section D-D, such that the wall panels 80000 present an exterior face substantially flush with the face of the frame. The frame segments 99200 can be formed from various materials, e.g., extruded aluminum. Wall panels 80000 can be secured in the frame using a metal-to-metal bonding such as SEM® 39537 weld bond. While the frame of FIG. 32 is rectangular and has four frame segments 99200, the frame can be any shape, including an n-sided closed polygon. FIG. 32 illustrates an overall rectangular eight-sided closed polygon assembled as a frame 99200. Zero or more supports 99600 can horizontally span the frame, and be secured to each wall section 10000 at the L flange parallel portion outer face 92000 using a metal-to-metal bonding such as SEM® 39537 weld bond. The horizontal supports 99600 can be tack welded to the vertical frame segments 99200.

Perimeter flats 99400 can be affixed to cover the abutment between each frame segment 99200 and the wall sections 10000, with a first portion of each flat 99400 covering a portion of each wall section 10000, and the remainder of each flat 99400 covering a portion of the frame segment 99200. FIG. 32 illustrates four (4) flats 994 miter-joined at the corners. The flats 99400 can be secured to each frame segment 99200 using various adhesives, e.g., methacrylate-based adhesives. In some embodiments, an adhesive sealant such as a single component, high strength, elastomeric sealant (for example, Hybrid adhesive sealant 76000 from 3M™) can be used at the interface between the flats 99400 and each wall section 10000.

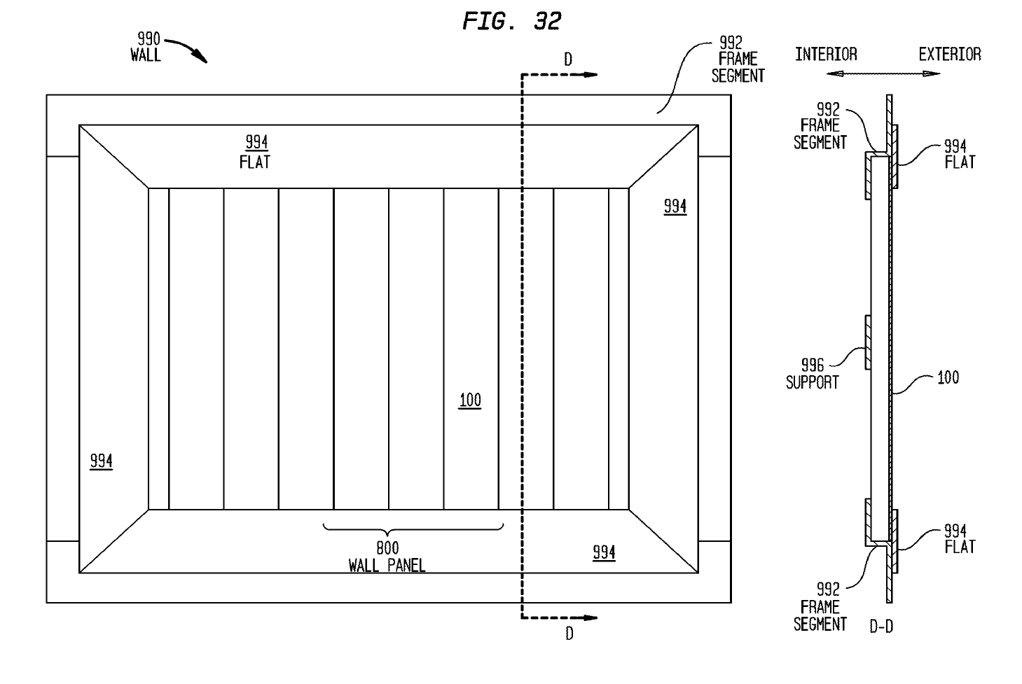

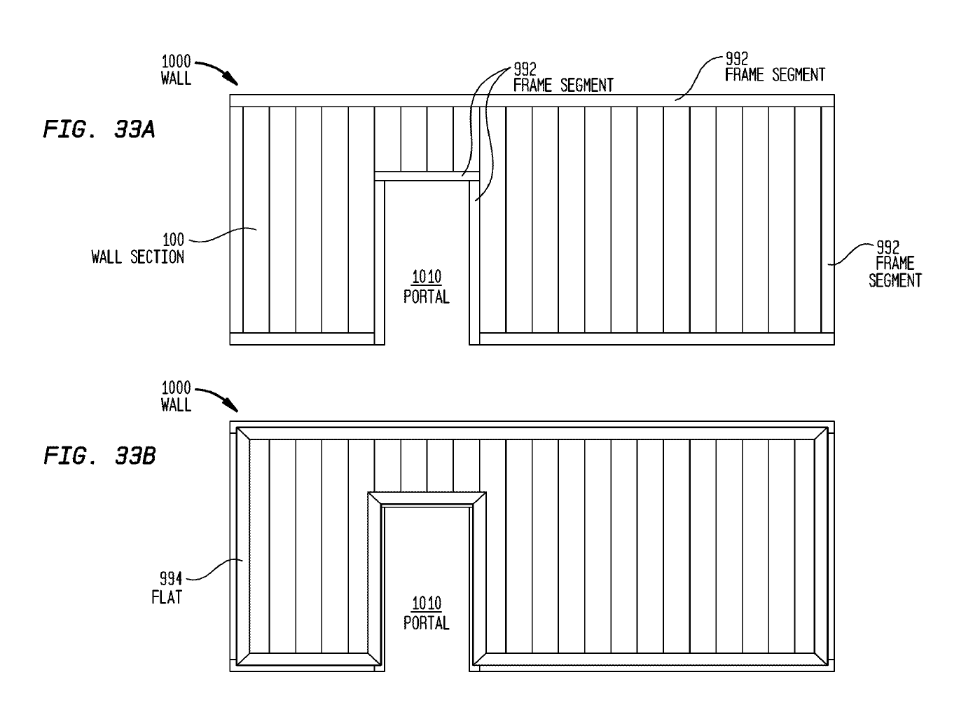

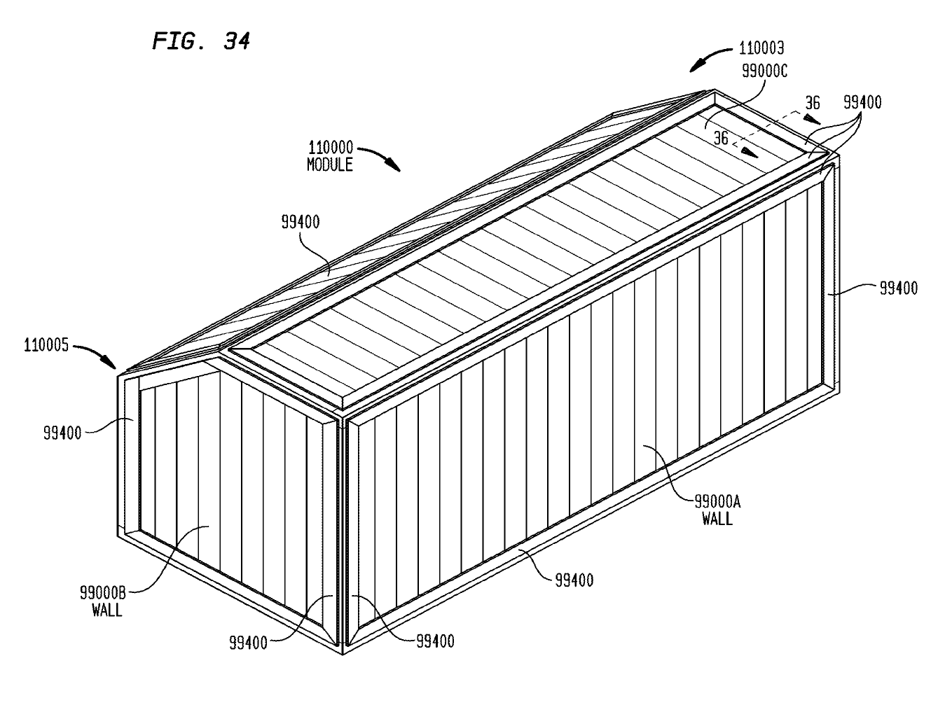

Referring to FIG. 33A, eight (8) frame segments 99200 are illustrated forming an 8-sided closed polygon to frame a module wall 100000, which is usable as a sidewall in any of the modules detailed herein and/or variations thereof, including a door 101000. While the frame forms an 8-sided polygon, the overall wall shape is rectangular with height less than width. Perimeter flats are not shown in FIG. 33A. The wall 100000 includes eighteen (18) full wall sections spanning the height of the wall, and four (4) shorter wall sections 10000 over the portal 101000. In FIG. 33B, eight (8) flats 99400 are affixed to the frame segments 99200 and the wall sections 10000. Each flat 99400 overlaps the abutment between a wall section 10000 and a frame segment 99200. Referring to FIG. 34, a module 110000 formed from walls 99000 of the present technology is shown in perspective view. Module 110000 includes long wall 99000A and short wall 99000B. As may be seen, module 100000 includes an end 110005, which when used in aircraft 120, faces forward, that has a wall 99000B closing the end off. In this regard, the module 110000 corresponds to module 112 of system 110. While not shown, module 110000 is open at end 1100003, thus permitting movement between that module and an adjacent module corresponding to, for example, module 114 of system 110, having an opening adjacent to the opening of module 110000.

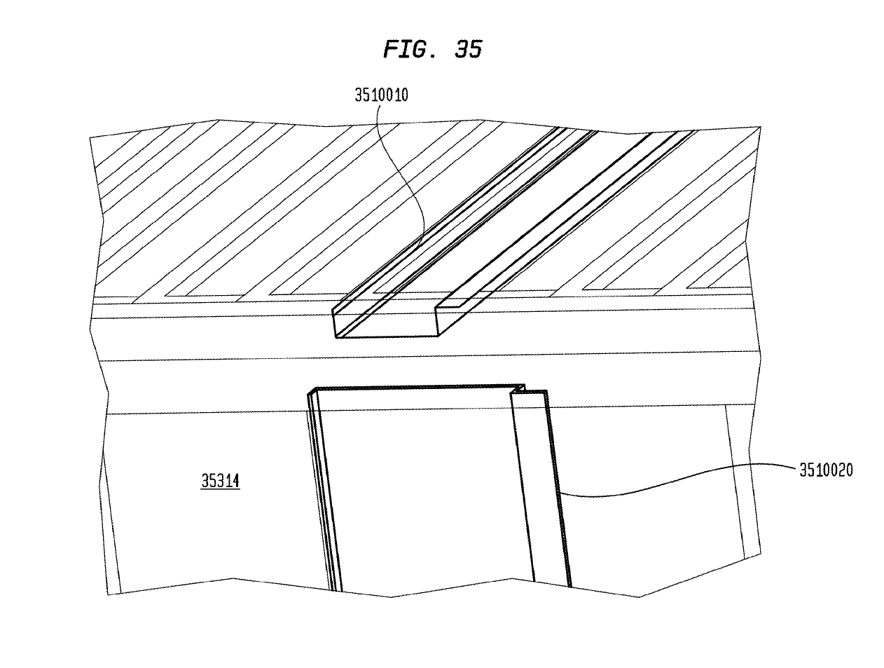

It is noted that the embodiment of FIG. 34 depicts module 110000 having a ceiling wall 99000C, where the wall 99000C utilizes wall sections that have the same cross-sectional dimensions as, for example, wall section 99000A and/or 99000B. However, in an alternate embodiment, the wall sections may have different cross-sectional dimensions. By way of example, referring back to FIG. 26, one or more or all of the wall sections of wall 99000C may have a width W1 (with reference to FIG. 26), that is less than the width W1 (again with reference to FIG. 26), of one or more or all of the wall sections 99000A and/or 99000B, or visa-versa. In this regard, FIG. 35 depicts a portion of an exemplary walled structure 3500 of an exemplary module. Wall 35310 corresponds to a ceiling wall (corresponding to wall 310 of module 114 of FIG. 3, in an exemplary embodiment), and wall 35314 corresponds to a sidewall (corresponding to wall 314 of module 114 of FIG. 3, in an exemplary embodiment). In this particular exemplary embodiment, wall 35310 is made up of a plurality of wall sections, at least one of which, such as wall section 3510010, has a width W1 of about 6 to about 10 inches and wall 35314 is made up of a plurality of wall sections, at least one of which, such as wall section 3510020, has a width W1 of about inches. In this exemplary embodiment, the other dimensions related to the cross-section are the same for all of the sections, although in other exemplary embodiments, one or more of the other dimensions is different.

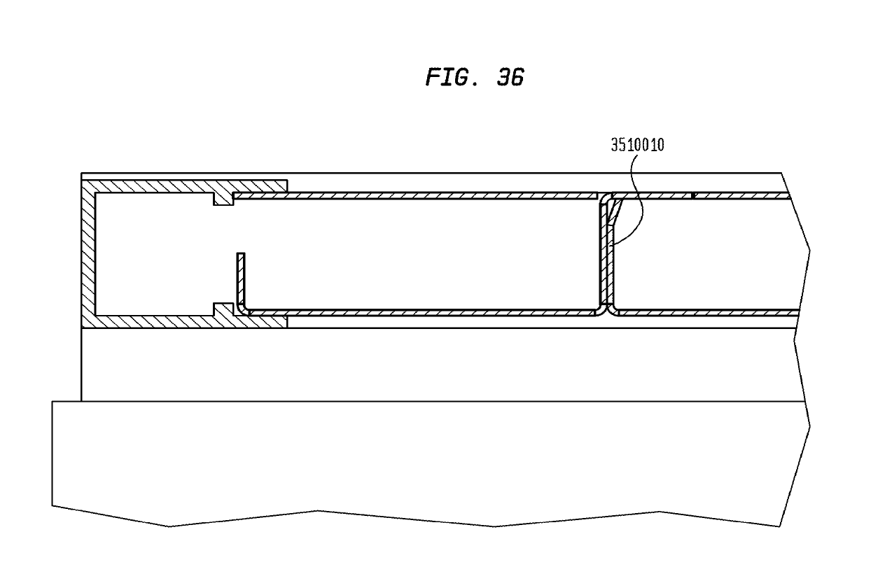

FIG. 36 depicts a cross-sectional view of a portion of module 35, depicting section 36-36 of FIG. 34.

In the exemplary embodiment where the ceiling walls have wall sections having a width W1 of less than that of the wall sections of another of the walls (e.g., a sidewall), the strength of the ceiling wall is enhanced, on a per-area basis, vis-à-vis a force applied normal to the wall (e.g., normal to the longitudinal axis). In an exemplary embodiment, this is due to the increased number of second flanges 13000 and L Flanges 12000 on a per-area basis. While various embodiments of the present technology have been described above, it should be understood that they have been presented by way of example only, and not limitation. For instance, while the wall sections disclosed herein have been disclosed in the context of vertical wall sections that can be assembled in to panels and walls of a module, the wall sections can be used as ceiling and floor elements in those applications, along with applications such as aircraft, ships, rail cars, modular buildings, and fixed construction. It will be apparent to persons skilled in the relevant art that various changes in form and detail can be made therein without departing from the spirit and scope of the technology. For instance, features described as part of one implementation can be used on another implementation to yield a still further implementation. Thus, the breadth and scope of the present technology should not be limited by any of the above-described exemplary embodiments, but should be defined only in accordance with the following claims and their equivalents.

It is noted that at least some and/or all of the aforementioned teachings herein, individually and/or collectively and/or in groups thereof, may be practiced with any number of modules and/or may be practiced with any type of overseascraft (e.g., aircraft, seacraft, etc.). Accordingly, exemplary embodiments include an overseas craft (e.g., aircraft or seacraft, etc.) that includes any of such teachings.

While various embodiments of the present technology have been described above, it should be understood that they have been presented by way of example only, and not limitation. It will be apparent to persons skilled in the relevant art that various changes in form and detail can be made therein without departing from the spirit and scope of the technology. Thus, the breadth and scope of the present technology should not be limited by any of the above-described exemplary embodiments, but should be defined only in accordance with the following claims and their equivalents.

1. A module of a transportable segmented enclosure system, comprising:
a first walled structure encompassing a volume having a longitudinal axis, the walled structure having at least a first opening, the longitudinal axis passing through the first opening; and
a seal apparatus located proximate the first opening, wherein
the seal apparatus is configured to form a seal between the first walled structure and another module having a walled structure when the seal apparatus of the first walled structure is positioned against the another module.

2. The module of claim 1, wherein:
the seal apparatus is an elastomeric seal configured to at least elastically deform when the module is positioned against the another module such that a compressive force is applied to the seal apparatus as a result of the positioning.

3. The module of claim 1, wherein the seal, in an undeformed state, has an outer periphery of a cross-section lying on a plane parallel to the longitudinal axis and passing therethrough that is bulbous.

4. The module of claim 1, wherein the seal is configured to form the seal as a result of contact of the seal with another module.

5. A transportable segmented enclosure system, comprising:
the module of claim 1; and
at least a second module including: a second walled structure encompassing a second volume having a second longitudinal axis, the second walled structure having at least a second opening, the longitudinal axis passing through the second opening, wherein
the first module and the second module are configured to be secured to one another and/or to another assembly such that the first opening is proximate the second opening and the seal apparatus forms a seal between the first module and the second module abut abutting the first and second openings.

6. An overseascraft, comprising:
an aircraft including a cabin; and
a transportable segmented enclosure system, including:
the module of claim 1; and
at least a second module including:
a second walled structure encompassing a second volume having a second longitudinal axis, the second walled structure having at least a second opening, the longitudinal axis passing through the second opening, wherein
the first module and the second module are located in the cabin and secured to one another and/or to the aircraft such that the first opening is proximate the second opening and the seal apparatus forms a seal between the first module and the second module abut abutting the first and second openings, wherein
the transportable segmented enclosure system is configured to maintain a pressure inside a volume thereof formed by at least some of collective volumes of the modules at a higher pressure than that outside the enclosure system inside the cabin.

7-8. (canceled)

9. An overseascraft, comprising:
an aircraft including a cabin; and
a transportable segmented enclosure system, including:
the module of claim 1; and
at least a second module including:
a second walled structure encompassing a second volume having a second longitudinal axis, the second walled structure having at least a second opening, the longitudinal axis passing through the second opening, wherein
the first module and the second module are located in the cabin and secured to one another and/or to the aircraft such that the first opening is proximate the second opening and the seal apparatus forms a seal between the first module and the second module abut abutting the first and second openings, wherein
at least one of the first module or the second module or collectively the first module and the second module is configured as an operating room.

10. A module of a transportable segmented enclosure system, comprising:
a first walled structure encompassing a first volume and having a first longitudinal axis; and
a first coupling component, wherein
the first walled structure is configured to couple to a second walled structure encompassing a second volume and having a second longitudinal axis via interface of the first coupling component with a second coupling component of the second walled structure such that the respective longitudinal axes are at least about parallel to one another and the volumes are proximate one another, and
the coupling components are configured such that, when interfacing with one another to achieve the coupling, the first walled structure can move relative to the second walled structure in a direction at least about parallel to the first longitudinal axis.

11. The module of claim 10, wherein:
the coupling components are configured such that, when interfacing with one another to achieve the coupling, the first walled structure can move relative to the second walled structure a first distance in a direction at least about parallel to the first longitudinal axis and is restrained from moving a second distance in direction normal to the longitudinal axis that is greater than about an order of magnitude less than the first distance.

12. The module of claim 10, wherein:
the coupling components are configured such that, when interfacing with one another to achieve the coupling, the first walled structure can move relative to the second walled structure distance of at least about a half an inch in a direction at least about parallel to the first longitudinal axis and is restrained from moving a second distance in direction normal to the longitudinal axis that is greater than about a quarter of an inch.

13. The module of claim 10, wherein:
the coupling components are configured such that, when interfacing with one another to achieve the coupling, the first walled structure can move relative to the second walled structure a first distance in a direction at least about parallel to the first longitudinal axis and is restrained from effectively moving in any direction normal to the longitudinal axis.

14. The module of claim 10, wherein:
the first coupling component includes a pin or a bore; and
the second coupling component includes the other of a pin or a bore, wherein the pin fits into the bore to achieve the interfacing.

15. The module of claim 10, wherein:
the first walled structure is configured to structurally reinforce the second walled structure when the coupling components interface with one another.

16. The module of claim 15, wherein: the first walled structure structurally reinforces the second walled structure via load distribution through the coupling components.

17-18. (canceled)

19. A module of a transportable segmented enclosures system, comprising:
a first walled structure encompassing a volume having a longitudinal axis, the first walled structure having a first wall and a second wall extending in a plane that is not parallel to that in which the first wall extends, wherein
the first walled structure further includes a first brace configured to resist movement of the first wall relative to the second wall due to a shear stress applied to one of the first and second walls.

20. The module of claim 19, wherein:
the first brace is coupled to the first wall and the second wall, the first brace being configured to resist a shearing force applied to one of the first wall and the second wall.

21. The module of claim 19, wherein:
the first walled structure has an opening normal to the longitudinal axis at the location of the brace.

22. The module of claim 19, wherein:
the first brace is a gusset plate.

23. A transportable segmented enclosure system, comprising:
the module of claim 19; and
at least a second module including:
a second walled structure encompassing a second volume having second longitudinal axis, the second walled structure having a third wall and a fourth wall both extending in planes that are at least about the same as extension planes of the first and second walls, wherein the second walled structure is coupled to the first walled structure such that the first brace resist movement of the third wall relative to the fourth wall due to a shear stress applied to one of the third and fourth walls.

24. (canceled)

25. An overseascraft, comprising:
an aircraft including a cabin; and
a transportable segmented enclosure system, including:
the module of claim 19; and
at least a second module including:
a second walled structure encompassing a second volume having second longitudinal axis, the second walled structure having a third wall and a fourth wall both extending in planes that are at least about the same as extension planes of the first and second walls, wherein
the second walled structure is coupled to the first walled structure such that the first brace resist movement of the third wall relative to the fourth wall due to a shear stress applied to one of the third and fourth walls, wherein the first module and the second module are located in the cabin and secured to one another and/or to the aircraft.

26-52. (canceled)
